(19) United States
(12) Patent Application Publication
(10) Pub. No.: US 2003/0233586 A1
(43) Pub. Date: Dec. 18, 2003

(54) Total service support system for employees and method therefor

(75) Inventors: Takeshi Urakami, Tokyo (JP); Sachio Fujimura, Tokyo (JP); Tatsuo Yoshioka, Tokyo (JP); Tomo Yashiki, Tokyo (JP); Reki Yamamoto, Tokyo (JP); Junichi Toyouchi, Tokyo (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/455,742

(22) Filed: Jun. 5, 2003

(30) Foreign Application Priority Data
Jun. 5, 2002 (JP) 2002-163715

(51) Int. Cl. G06F 12/14

(52) U.S. Cl. 713/202; 713/201

(57) ABSTRACT

Login operation leads a user (e.g., employee) to an integrated portal platform 29, in which centralized management of IDs of the user for each specialized service site is carried out to realize a single sign-on scheme. Individual information of the who has accessed the system is located by looking up an individual information database in a transactions system 30, and utilizing the individual information, a list of available services is customized to suit the user. Accordingly, a front page that appears immediately after the login operation includes a customized screen with a customized menu. Subsequently, by specifying a preferred item of the menu, the user automatically logs into specialized service groups 31, and a service corresponding to the specified item of the menu is provided via the platform 29 to the user.

### BACKGROUND OF THE INVENTION

This invention relates to a total service support system for employees and a method therefor, and more particularly to a system and method for providing employees with information on transactions supports and welfare services for the employees on computer terminals.

These days, most of divisional organizations and corporate bodies provide their employees with transactions supports for the employees through computer terminals operated by the employees. A support menu thereof for example includes reference to a rule book, downloadable blank forms for various procedures or electronic form submission support for the procedures, assembly room reservation, house journals, bulletin board systems, business trip arrangements, yearly allocated paid holidays, salary payment statements, and the like.

With respect to the welfare services, if one or more of tie-ups with external corporate bodies are established without limiting the services to in-house ones, the service menu for the employees becomes extensive. Moreover, outsourcing the services for employees has been sought. Among such external services, for example, are in-house bulk buy clubs, self-development supports, asset-building supports, real estate-related supports, and the like.

Meanwhile, disclosed in JP 11-96099 A (corresponding to U.S. patent application Ser. No. 09/153,873 filed on Sep. 16, 1998) is a computer service that evaluates a request history and preferences of a user and provides the user with information fit therefor.

The aforementioned external services are provided by introducing possible service providers expected to offer the corresponding services to users, and each contract is supposed to be made by an individual user at his/her own risk with the respective service provider. Therefore, there should be provided a login ID and password pair for each service or service provider, to which the user should get access respectively.

The technique disclosed in the above publication only displays a screen selected on the basis of the user's history and preference data.

Therefore, it is an exemplified object of the present invention to provide a system and method that serve to save employees logging in to the system each time for each service provided, and to allow the login process to be customized into a single-login process.

In this application, the corporate body includes national and municipal organizations, and thus the employee is the concept including civil servants.

### SUMMARY OF THE INVENTION

The present invention is implemented by a combined use of an individual information database storing employees' individual data under the charge of the labor section, whatever you may call it, and an integrated platform providing access to a menu for each service. The present invention is embodied in providing an employee who has logged in to the system with information and services customized to suit the employee.

In one aspect, to be more specific, a total service support system for employees, who belong to an organization such as a divisional organization and a corporate body, according to the present invention includes an individual information database in which individual information on each employee is stored, an information database in which information of the organization available to the employees is stored, and a server that provides links to external service sites provided in affiliation to the organization. Each of the above databases is connected with the server and a plurality of terminals available to the employees through means of communication. Each of the above terminals includes a visual display unit, on a screen of which appears a login prompt to be responded to by one of the employees who accesses the system using the terminal, and the server obtains individual information of the employee by searching the individual information database based upon an ID and password inputted by the employee, to display a navigation screen designed specifically for the employee. The navigation screen has a menu of items related to the information database and those related to the external service sites, arranged in a manner customized to suit the employee.

In this system, the individual information may preferably include information selected from the group consisting of date of birth, family makeup, residence data, commute data, marital status, and membership, in addition to essential information of sex, age, date of entry into the organization, section and post.

Preferably, the server exercises centralized management of IDs accessible to each of the external service sites, utilizing information obtained from the individual information database, so that the employee signs on internal services as well as external services provided in the external service sites in a single login operation.

Moreover, the server may preferably be connected through means of communication with an additional individual information database in which individual information on voluntary registrants is stored, which registrants include family members of the employees and/or retired persons who have been registered therein and allowed to access the system at their own wishes, so that the server may obtain individual information of one of the voluntary registrants who has accessed the system by searching the additional individual information database based upon an ID and password inputted by the voluntary registrant, to display a navigation screen designed specifically for the voluntary registrant. The above navigation screen has a menu of items related to the information database and those related to the external service sites, arranged in a manner customized to suit the voluntary registrant.

A total service support method for employees according to another exemplified aspect of the present invention includes the steps of allowing the employees to log in to a system in response to a login prompt displayed on a screen of a computer terminal of each employee; allowing a server to obtain by means of login information inputted by the employee individual information of the employee who has accessed the system, so that the employee signs on some of affiliated service sites preassigned to the employee at the same time; and displaying a listing of the service sites on the screen, wherein selection and arrangement of the service sites to be displayed in the listing is customized in accordance with the individual information.

In this method, in addition to the listing of the service sites, preferably, specific items of notification information selected according to who and when has accessed the system may be displayed. Further, the individual information may preferably include information selected from the group consisting of date of birth, family makeup, residence data, commute data marital status, and membership, in addition to essential information of sex, age, date of entry into the organization, section and post.

Preferably, the server exercises centralized management of IDs accessible to each of the service sites, utilizing the individual information obtained by means of the login information, so that the employee signs on internal services as well as external services provided in the affiliated service sites in a single login operation.

Moreover, the server may preferably be configured to obtain individual information of a voluntary registrant who accessed the system among those including family members of the employees and/or retired persons who have been registered in an individual information database of the system and allowed to access the system at their own wishes, by searching the individual information database based upon an ID and password inputted by the voluntary registrant, to display a navigation screen designed specifically for the voluntary registrant, whereas the navigation screen has a menu of items related to internal services and those related to external services provided in the affiliated service sites, arranged in a manner customized to suit the voluntary registrant.

Other objects and further features of the present invention will become readily apparent from the following description of preferred embodiments with reference to accompanying drawings.

### BRIEF DESCRIPTION OF THE DRAWINGS

FIG. 1 is an exemplified representation of a login screen for use in the present invention.

FIG. 2 is an exemplified on-screen representation of a customized webpage that is displayed first after a user logs in to a service according to the present invention.

FIG. 3 is an exemplified on-screen representation for explaining an operation to specify items to be displayed on the screen as shown in FIG. 2.

FIG. 4 is an example of on-screen representations of webpages linked from the webpage as shown in FIG. 2.

FIG. 5 is another example of on-screen representations of the webpages linked from the webpage as shown in FIG. 2.

FIG. 6 is an example of on-screen representations of webpages linked from the webpage as shown in FIG. 5.

FIG. 7 is yet another example of on-screen representations of the webpages linked from the webpage as shown in FIG. 2.

FIG. 8 is another exemplified on-screen representation of a customized webpage that is displayed first after a user logs in to a service according to the present invention.

FIG. 9 is an example of on-screen representations of webpages linked from the webpage as shown in FIG. 8.

FIG. 10 is an example of on-screen representations of webpages linked from the webpage as shown in FIG. 9.

FIG. 11 is another example of on screen representations of the webpages linked from the webpage as shown in FIG. 8.

FIG. 12 is an example of on screen representations of webpages linked from the webpage as shown in FIG. 11.

FIG. 13 is another example of on-screen representations of the webpages linked from the webpage as shown in FIG. 11.

FIG. 14 is yet another example of on-screen representations of the webpages linked from the webpage as shown in FIG. 8.

FIG. 15 is a conceptual diagram of exemplified system architecture according to the present invention.

FIG. 16 is a diagram for explaining one aspect of advantages brought by implementing an exemplified embodiment of the present invention.

FIG. 17 is a correlation chart of participating parties in an exemplified embodiment of a system according to the present invention.

FIG. 18 is a diagram for explaining another aspect of advantages bought by implementing an exemplified embodiment of the present invention.

FIG. 19 is a schematic diagram of an exemplified embodiment of the system according to the present invention.

FIG. 20 is a schematic diagram showing a flow of services implemented according to an exemplified embodiment of the present invention

FIG. 21 is a preferred embodiment of a system configuration for use in the present invention.

FIG. 22 shows one example of a service mediation policy table.

FIG. 23 shows one example of a service requesting client table.

FIG. 24 shows one example of an available service table.

FIG. 25 shows one example of a format of an available service registration message to be transmitted from a service offering server to a service mediation server.

FIG. 26 shows one example of a format of a service request message to be transmitted from a service requesting client to the service mediation server.

FIG. 27 is a flowchart for a registration process of a service to be provided from the service offering server, in the service mediation server.

FIG. 28 is a flowchart for a registration process of service requesting client information, in the service mediation server.

FIG. 29 is a flowchart for a process of requesting a service from the service requesting client, in the service mediation server.

FIG. 30 is a flowchart for a process of controlling service distribution of a service mediation agent, in the service mediation server.

FIG. 31 is another exemplified embodiment of the system configuration for use in the present invention.

FIG. 32 is yet another exemplified embodiment of the system configuration for use in the present invention.

FIG. 33 is yet another exemplified embodiment of the system configuration for use in the present invention.

### DETAILED DESCRIPTION OF THE PREFERRED EMBODIMENTS

The present invention will now be described in detail by illustrating preferred embodiments thereof.

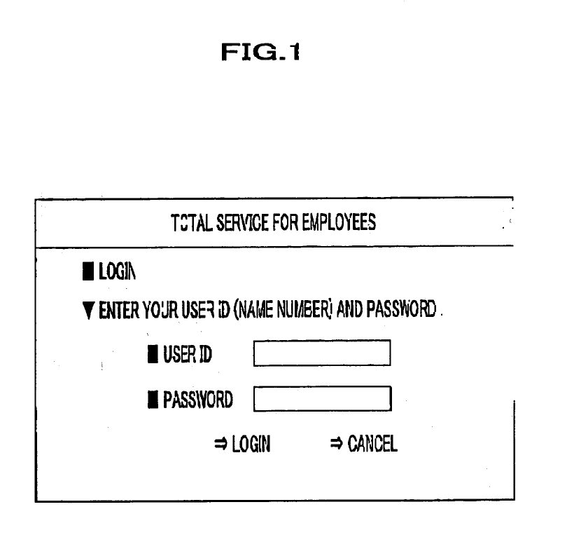

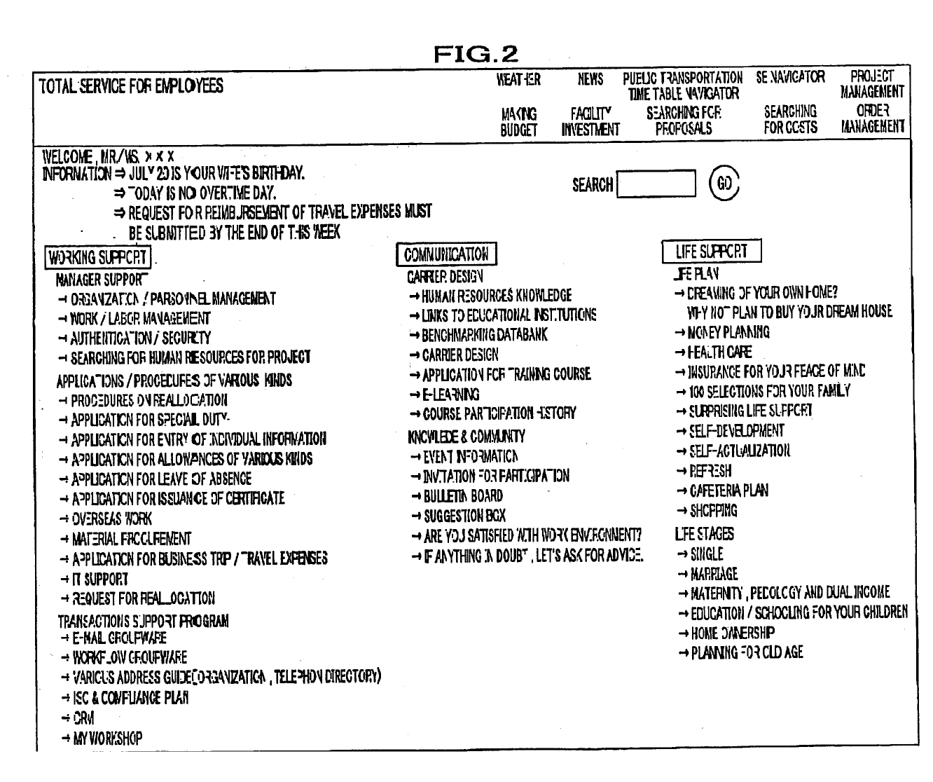

FIG. 1 represents a login screen displayed at computer terminal equipment (hereinafter referred to as personal computer or PC) that is used by an employee. On the screen are provided blank fields, in which the employee fills with a user ID (name number) and a password. A server that has received a user ID/password pair of the employee in turn retrieves individual information of the employee who has inputted the ID/password pair, from an individual information database, and displays on a subsequent screen a “my page” customized to suit the employee. FIG. 2 is an exemplified on-screen representation of the “my page”.

Assuming that the employee who has made an access to the server is a fiftysomething married man, the “my page” may include a notification such as “today is the birthday of someone in his/her family (or the anniversary of something)”, and if he is a manager, include a manager support menu. An anniversary or family birthday message that appears on the screen as above is provided with links to service sites such as shopping malls. Similarly, assuming that the employee who has made an access to the server is in his/her twenties, the “my page” may include notifications linked to self-development activities, activities of his/her affiliation group, or his/her hobbies, and if he/she is unmarried, include links to marriage-related information.

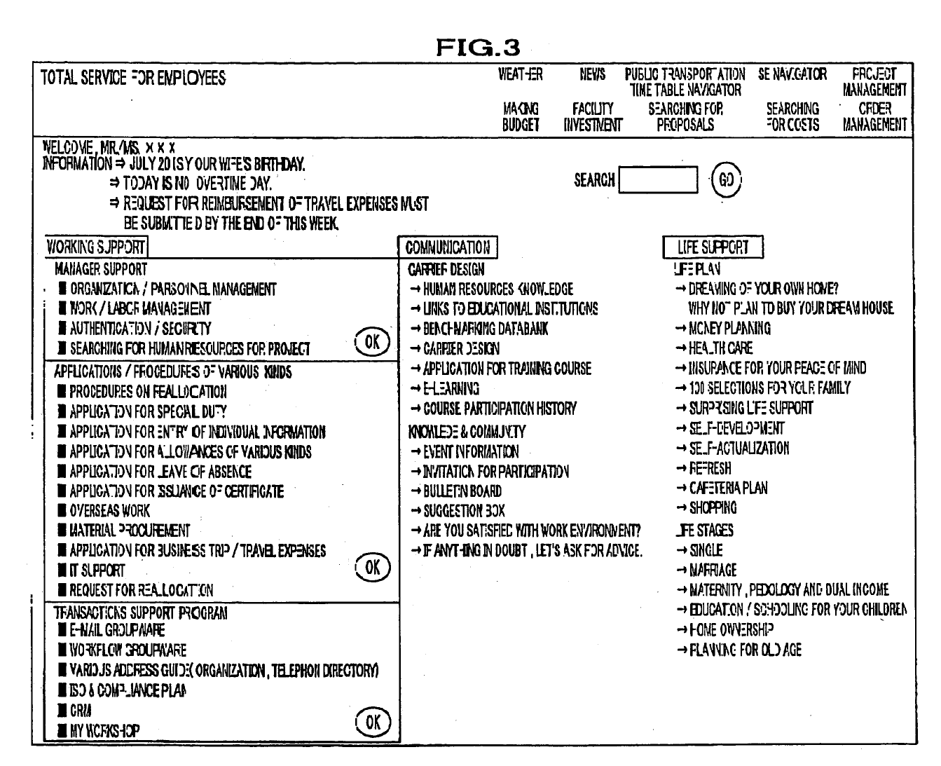

To take, as an example, a fiftysomething male manager, the “my page” that appears immediately after his login operation not only includes notifications (or “INFORMATION” as indicated in FIG. 2), but also three sections; i.e., “WORKING SUPPORT”, “COMMUNICATION” and “LIFE SUPPORT”, each having a specific list of items enumerated as a menu. More specifically, as shown in FIG. 3, to determine what items to be listed in each section, he may click on a title block on the like of the section to have a checklist of the displayable items listed, and select and click on desired items to checkmark the desired items. Thus-checkmarked items will appear in the section, and he may select and click on one of the items to view details pertinent to the selected item or get access to a relevant information site. In addition, beside the heading (“TOTAL SERVICE FOR EMPLOYEES” in this instance) is a customized list of clickable keywords which includes “Weather”, “News”, Public Transportation Time Table Navigator”, “SE Navigator”, “Project Management”, “Making Budget”, “Facility Investment”, “Searching for Proposals”, “Searching for Costs” and “Order Management”.

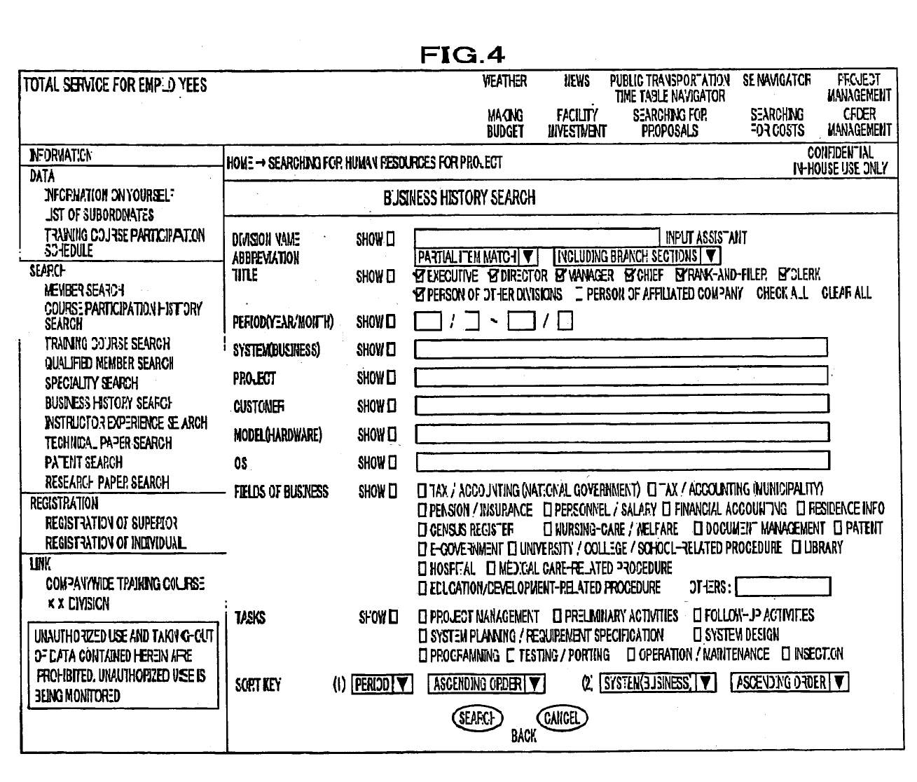

In the exemplified on-screen representation as shown in FIGS. 2 and 3, the “WORKING SUPPORT” section has “Manager Support”, “Applications/Procedures of Various Kinds” and “Transactions Support Program” blocks, and each block has a detailed list of items enumerated as a menu. The “Manager Support” block is targeted for a manager; for example, if a manager clicks on a menu item of the “Searching for Human Resources for Project”, the screen therefor (“Business History Search” screen) as shown in FIG. 4 appears, and if the manager follows an instruction on the screen and enters predetermined items, employees suitable for a project can be located. Likewise, each item of the “WORKING SUPPORT” section provides information, searching instruments, application tools and the like. This section is specifically designed to support corporate business transactions. In contrast, the “COMMUNICATION” section in FIG. 3 is partly designed to support business transactions, and not only includes information on self-development, learning support and the like, and provides searching instruments and application tools, but also a menu for communication such as a bulletin board (BBS), and a chat.

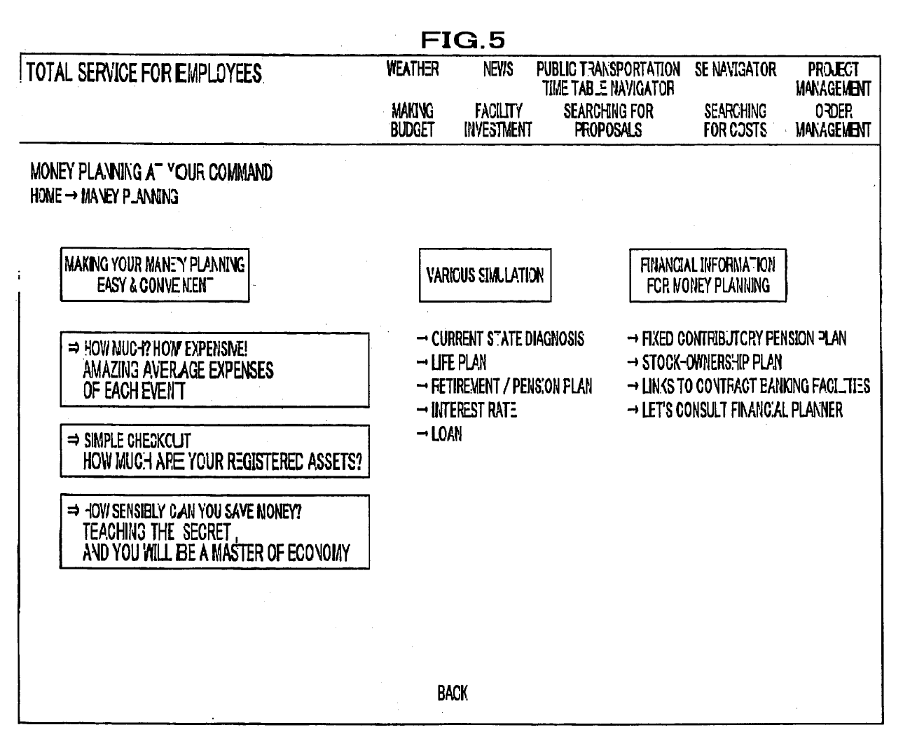

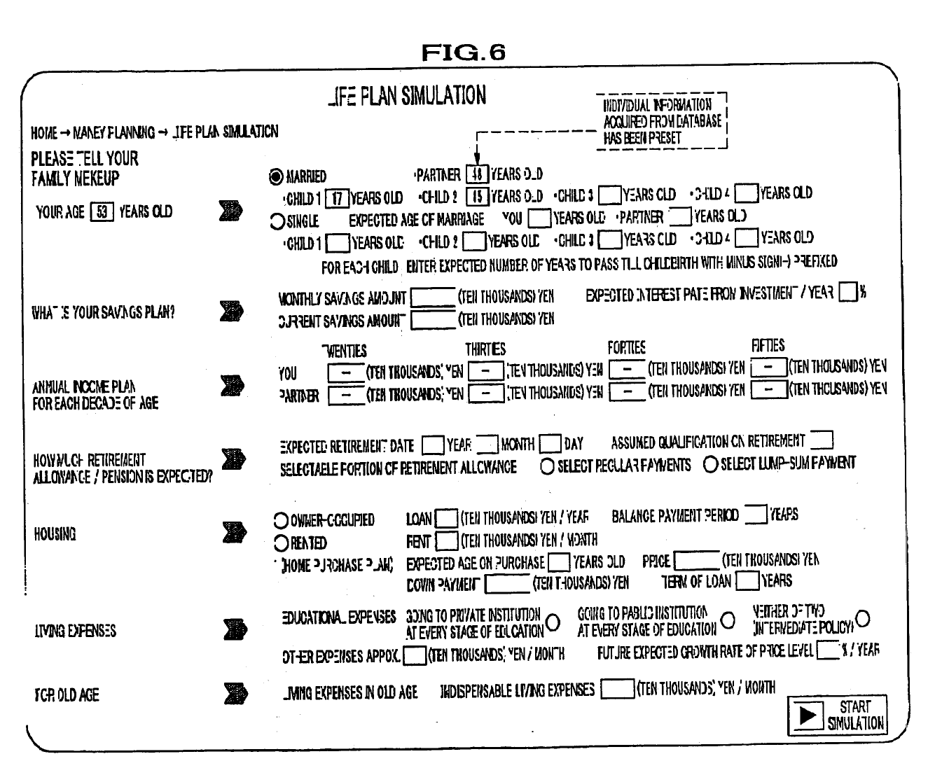

The “LIFE SUPPORT” section in FIG. 3 is specifically designed to provide welfare services or equivalents thereof that serve to support employees' personal lives. As seen in a menu of FIG. 3, a “Life Plan” block provides services related to a money planning, an anniversary plan (e.g., “100 Selections for Your Family”, “Shopping”, etc.), and the like, as well as links to external affiliated service sites. When he clicks on an item “Money Planning”, for example, he will be presented with a screen as shown in FIG. 5, in which he may go to a procedure for a fixed contributory pension plan or to one of contract banking facilities sites, or may run a simulation of various kinds for a life plan or the like. Shown in FIG. 6 is an example of the simulation screen for a life plan.

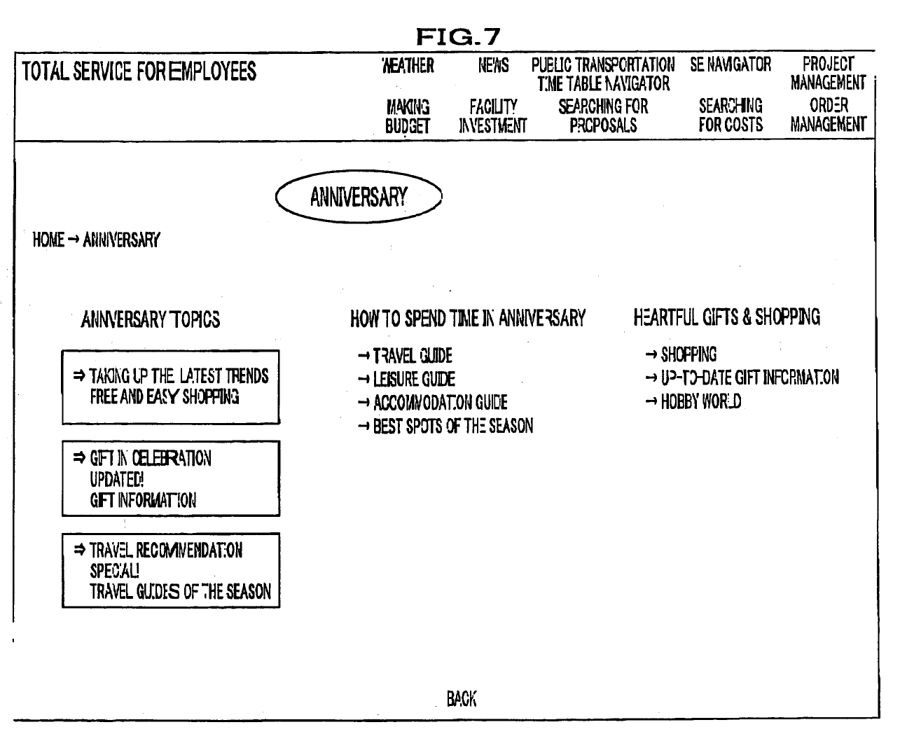

If any anniversary information such as of a family birthday is presented in the notification column (“INFORMATION”) of FIG. 3, once he clicks on a hot link of the information, he goes directly to an “Anniversary” screen as shown in FIG. 7, or once he clicks on an anniversary-related hot link, he may be navigated to go to the “Anniversary” screen. In the “Anniversary” screen, he is provided with links to a subsection such as of shopping and gift information, in which he may get a gift or enjoy an E-shopping.

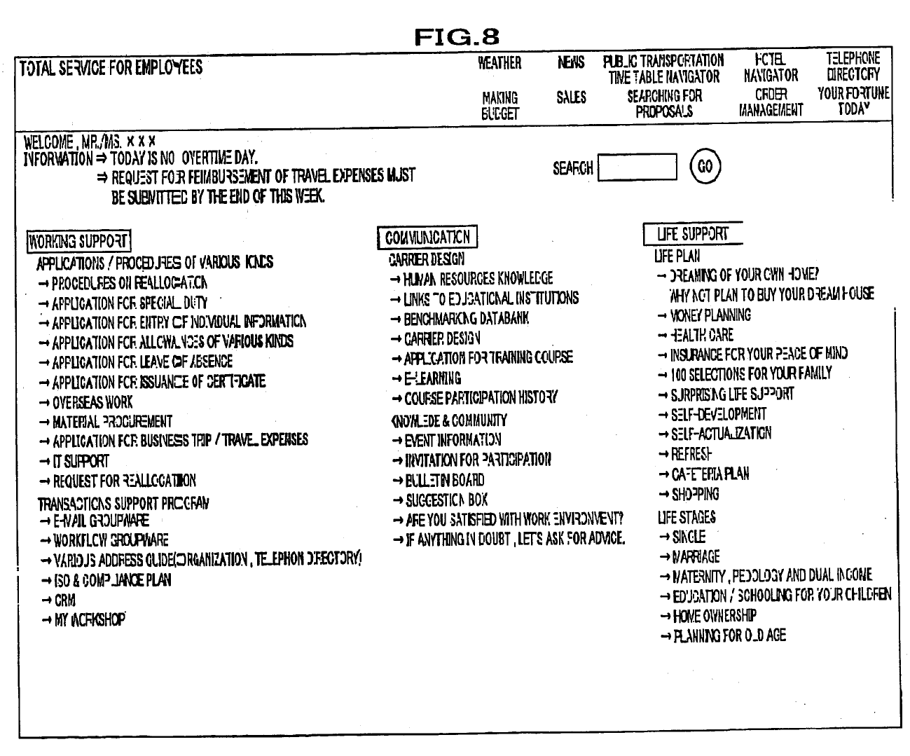

Similarly, assuming that the employee who has inputted her own ID/password pair in the login screen as shown in FIG. 1 is a twentysomething unmarried female, not in a managerial position, she is presented with a customized screen as shown in FIG. 8. Unlike the screen shown in FIG. 2, the screen shown in FIG. 8 does not include the “Manager Support” block, but instead has menu items for meeting her needs such as a fortune-teller service (“Your Fortune Today”). What items to be listed in each column on the screen, or whether the menu on the screen is to be customized, may be predetermined by herself in such a manner as described above with reference to FIG. 3.

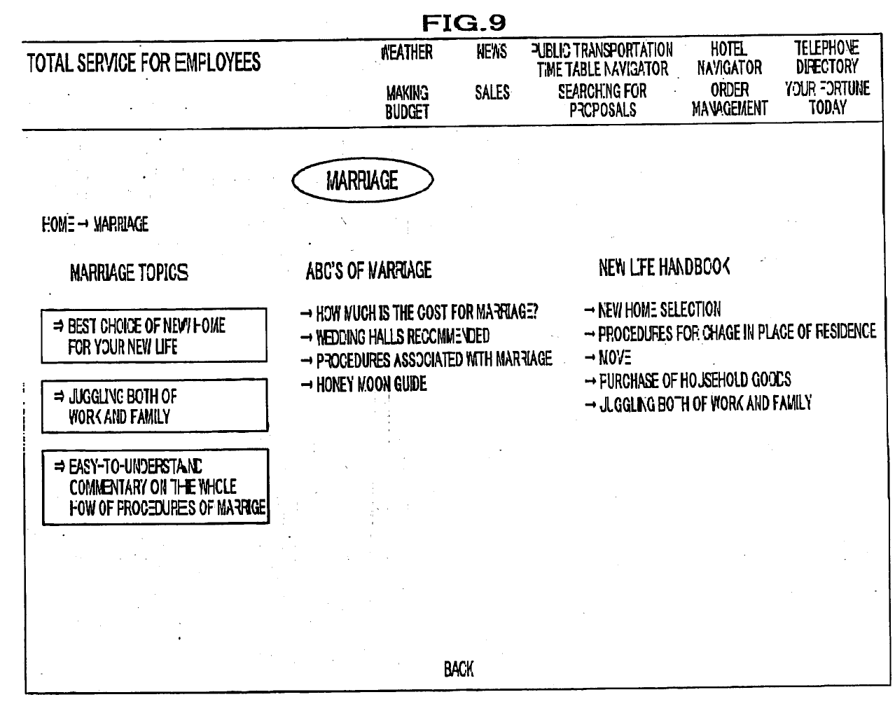

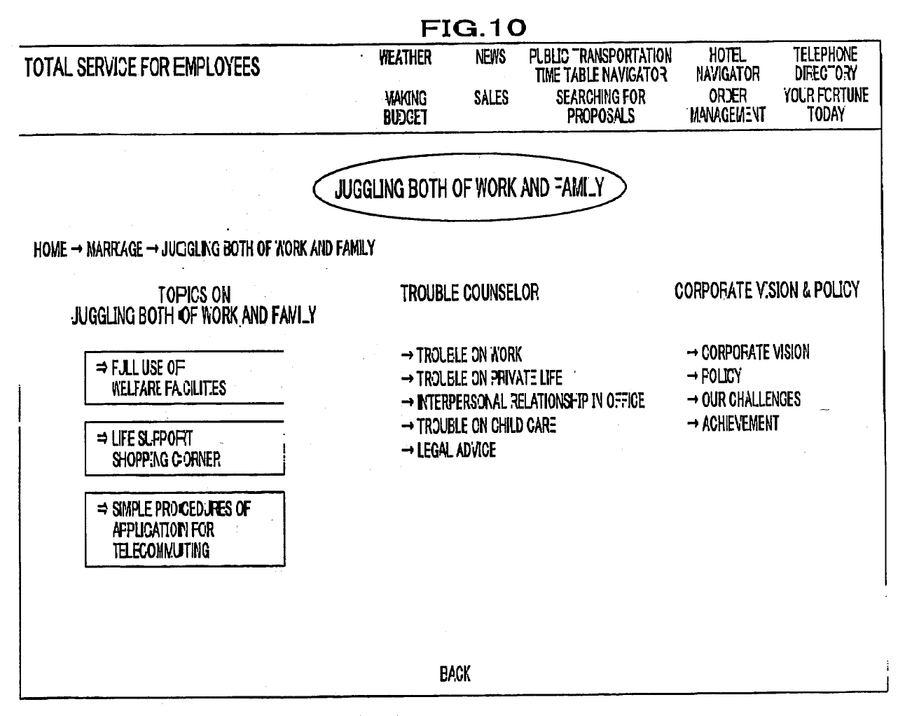

When she clicks on an item “Marriage” in the “Life Stage” block, she is presented with a screen related to the marriage as shown in FIG. 9, in which are provided various items on new life support (“New Life Handbook”) such as real estate agents for a new home, relocation services, advices for purchasing household goods, procedures for change in place of residence, etc., and on marriage-related tips (“ABC's of Marriage”) such as wedding hall recommendations, honey moon guides, procedures associated with the marriage, etc., allowing her to obtain detailed explanations on each item and to make an arrangement through the system. For example, in a relocation services site or a travel services site, they provide information suitable for the user and make an electronic shopping mall capability available with which she can directly apply for a ticket to an agency. Moreover, she may go to a screen as shown in FIG. 10 in which valuable advice and legal information on juggling of both work and family are available. It is understood that in a case where the employee who has inputted his own ID/password pair in the login screen as shown in FIG. 1 is a twentysomething single male, not in a managerial position, he is presented with a customized screen similar to that as shown in FIG. 8.

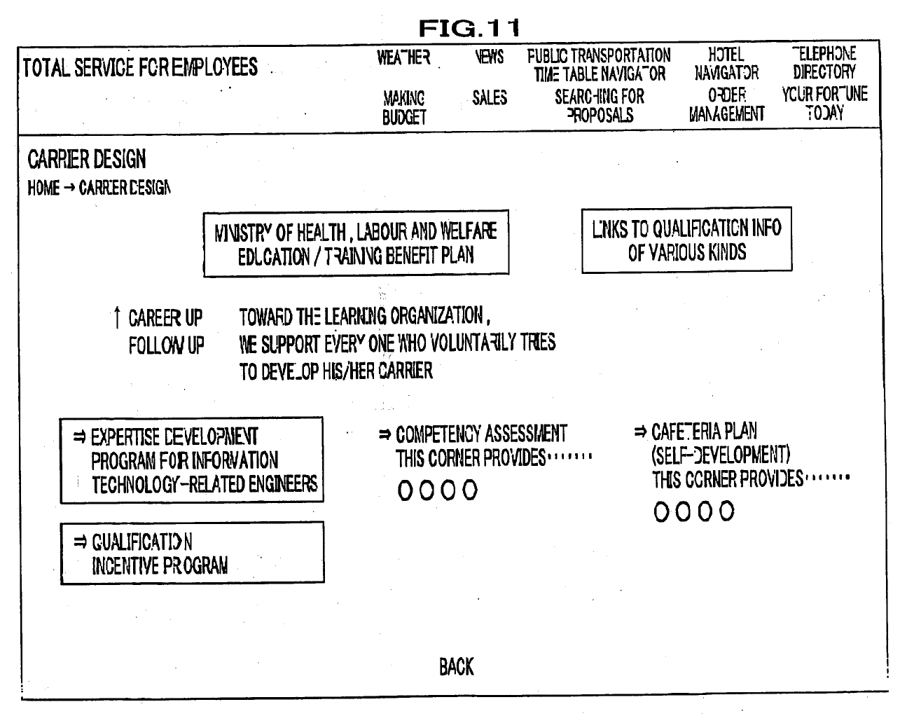

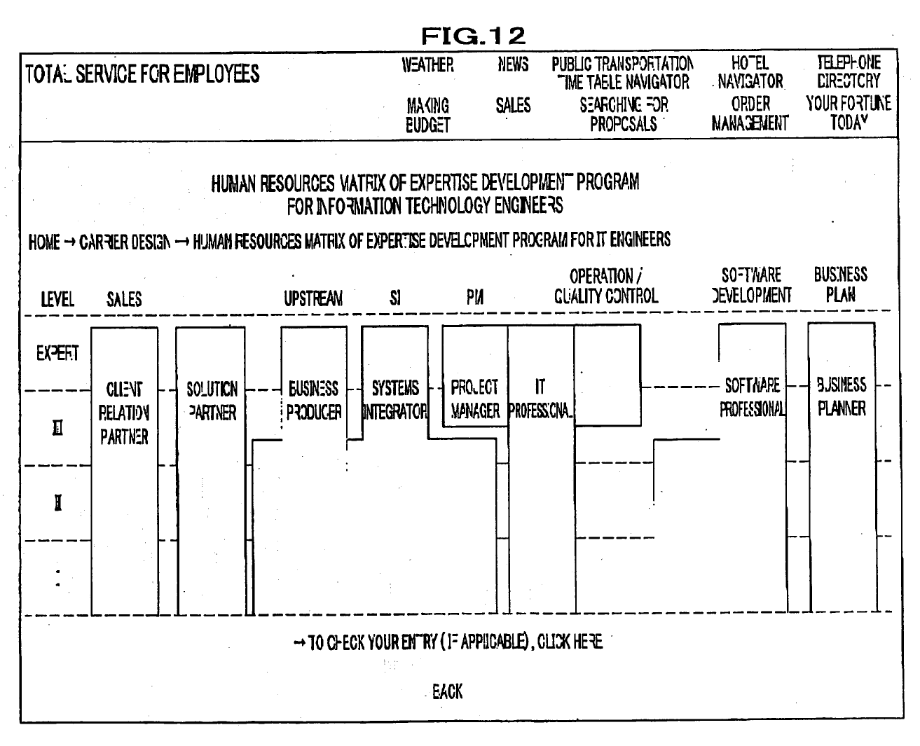

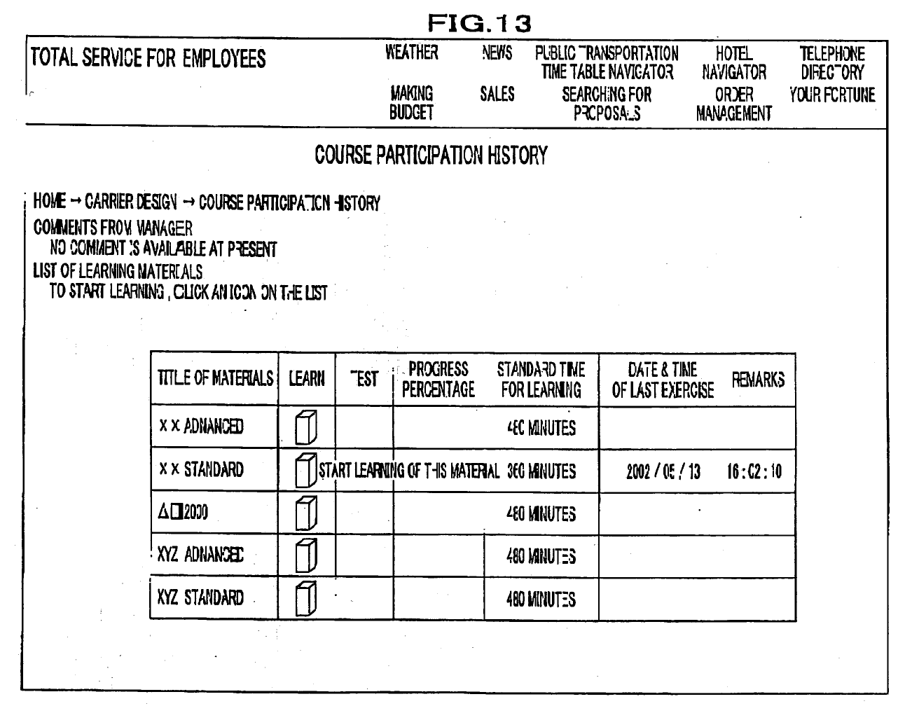

When a user selects an item “Carrier Design” in a “Carrier Design” block of the “COMMUNICATION” section, a guidance screen as shown in FIG. 11 appears, and if the user selects a job category and clicks on an item such as “Expertise Development Program for Information Technology (IT)-related Engineers” on the guidance screen, a matrix of expertise development program as shown in FIG. 12 appears to show possible qualifications and levels for the job category. The user may click on an indication to go to the next screen to check his/her entry of current qualification and level. Another example of the screens linked from the guidance screen shown in FIG. 11 is a “Course Participation History” as shown in FIG. 13, in which the user can check your current level of competence or qualification placed according to the course participation history.

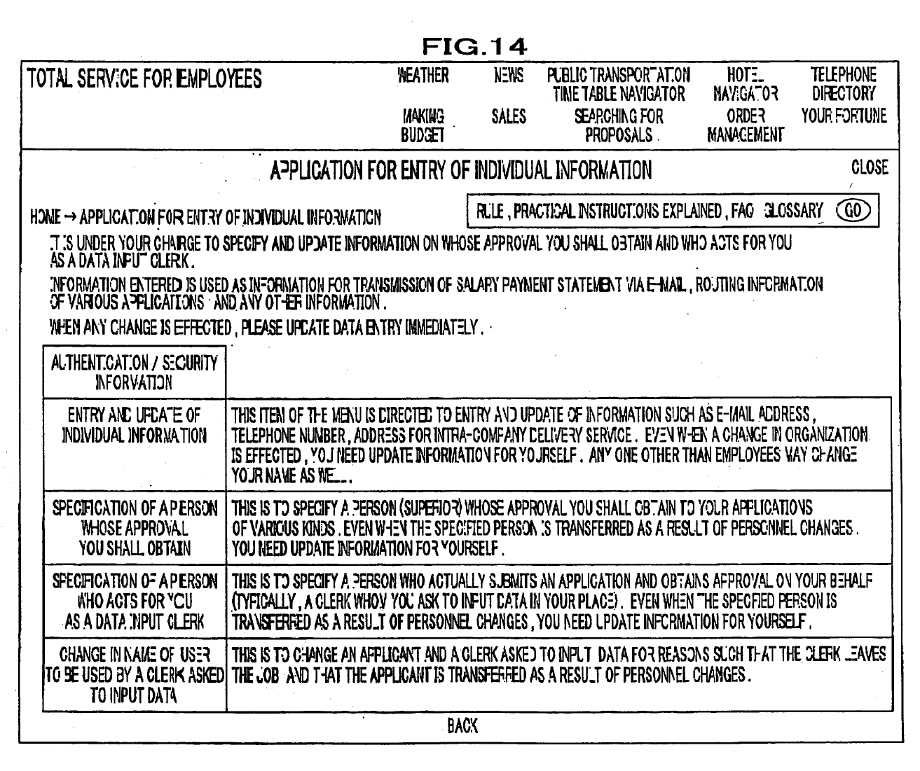

To apply for entry or update of individual information, a user (employee of a company or other organizations) clicks on an item “Application for Entry of Individual Information” in a “Applications/Procedures of Various Kinds” block of the “WORKING SUPPORT” section as shown in FIG. 8. The individual information on a user is essentially comprised of job-related data, and thus basic data thereof which include sex, age, date of entry into the organization, family makeup, commuting method, qualification, post (job title in the organization), and the like are timely updated utilizing update information from the personnel information system of the organization. However, other information such as hobbies, specialties, a telephone number, a person whose approval the user shall obtain, a person who acts for the user as a data input clerk, information on membership of external organizations may also be included, and inputted as appropriate. An example of on-screen representations of the “Application for Entry of Individual Information” is shown in FIG. 14.

Although the above discussion has been given on the premise that the user is the employee of the company or other organizations, some services may be extensively applied to retired persons who once were employees, and family members of the employees. Access schemes and hyperlink structures of the system for the retired and the family members may be the same as those for the employees. It is however noted that there should be confidential or secret information of which leakage is strictly restricted to persons outside the organization, in the system.

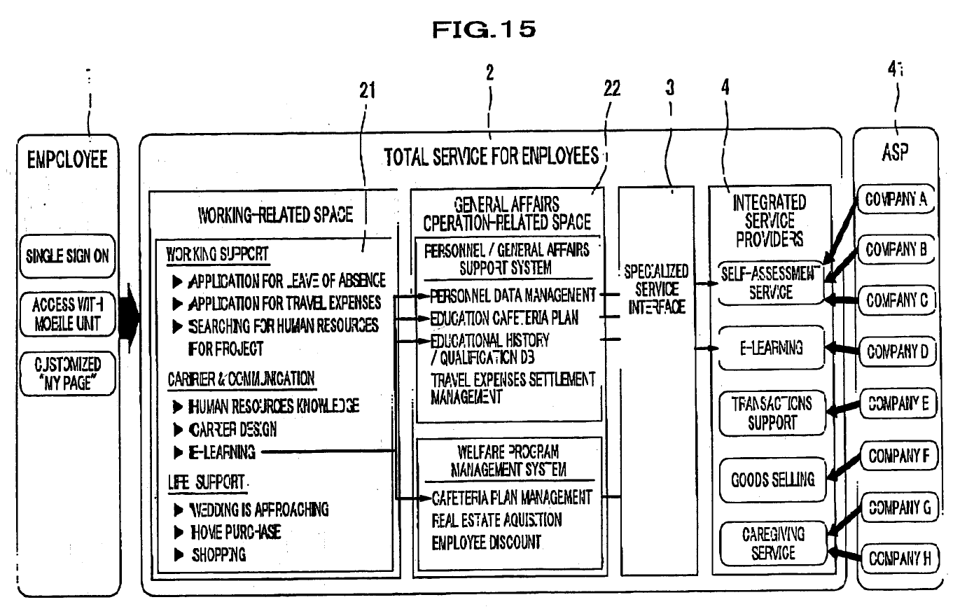

Referring to FIG. 15, a brief description will be given of features of an integrated portal platform as the core for a typical embodiment of the present invention. Specifically, great-flexibility integrated portal platform can be realized by well-combined three-space structure as follows. (1) WORKING-RELATED SPACE, which provides service menus customized to suit the jobs and needs of the employees; (2) GENERAL AFFAIRS OPERATION-RELATED SPACE, which associates the general affairs operations of various kinds with each other and serves to considerably improve efficiency; and (3) VALUE-ADDED SPACE, which provides integrated service provider functions in addition to the above (1) and (2), making it possible to combine abundant external professional services with ease.

An employee 1 or other person who accesses the system can establish connection via a terminal including a mobile communication unit. The employee or other person who has accessed the system is provided with a menu of items from various sources displayed on the screen of the terminal in a single login operation. A front page, which appears immediately after the login screen, is customized to suit the employee 1 or other person who has accessed the system, and displayed as his/her own “my page”

The “my page” is presented as a customized screen of an integrated portal service 2, and menu items covers a wide range, which is however limited to that as customized. For example, the WORKING-RELATED SPACE 21 may include a working/transactions support menu, a life plan support menu, and a retiree support menu. In the working/transactions support menu, items such as an application for leave of absence, an application for travel expenses, a self-development and an e-learning are offered for choice; in the life plan support menu, items such as marriage-related information, home purchase tips and shopping are offered for choice; and in the retiree support menu, items for services directed to persons who left the office are offered for choice.

Each item of the menu selectable in the WORKING RELATED SPACE 21 is connected to databases of various kinds and support software therefor related to a personnel/general affairs support or a welfare program management in the GENERAL AFFAIRS OPERATION-RELATED SPACE 22. In a personnel/general affairs support menu, items such as a personnel data management, an education cafeteria plan, an educational history/qualification database and a travel expenses settlement management are offered as a software program or a database. The cafeteria plan is a system in which employees use their points granted as fringe benefits, like a local currency, to buy services or goods in the form of voluntary application for consuming the points. If a charge for using the points exceeds the amount corresponding to their remaining points, the excess may be settled separately by payment, carried forward to the next term of the grant of points, deducted from pay, or transferred to an in-house loan. In a welfare program management menu, items such as a cafeteria plan management, a real estate acquisition and an employee discount are offered as a software program or a database. The services of various kinds provided through the above databases and software programs are linked through a specialized service interface 3 to each site of integrated service providers 4. The integrated service providers 4 may for example include a classified menu of items such as a self-assessment service, an e-learning, a transactions support, a goods selling and a caregiving service. Each item of the menu is linked to a site ASP 41 provided respectively by specialized service providers (not only including companies but also government and public agencies, non-profit organizations, schools, and the like) in affiliation to the organization, systematically allowing the user to enter the site smoothly while following links from the portal site. In the instant embodiment, the ASP 41 corresponds to the integrated service providers 4. For example, the contents that are offered by the integrated service providers 4 and realized in the VALUE-ADDED SPACE include the self-assessment service, e-learning, transactions support, goods selling, and caregiving service.

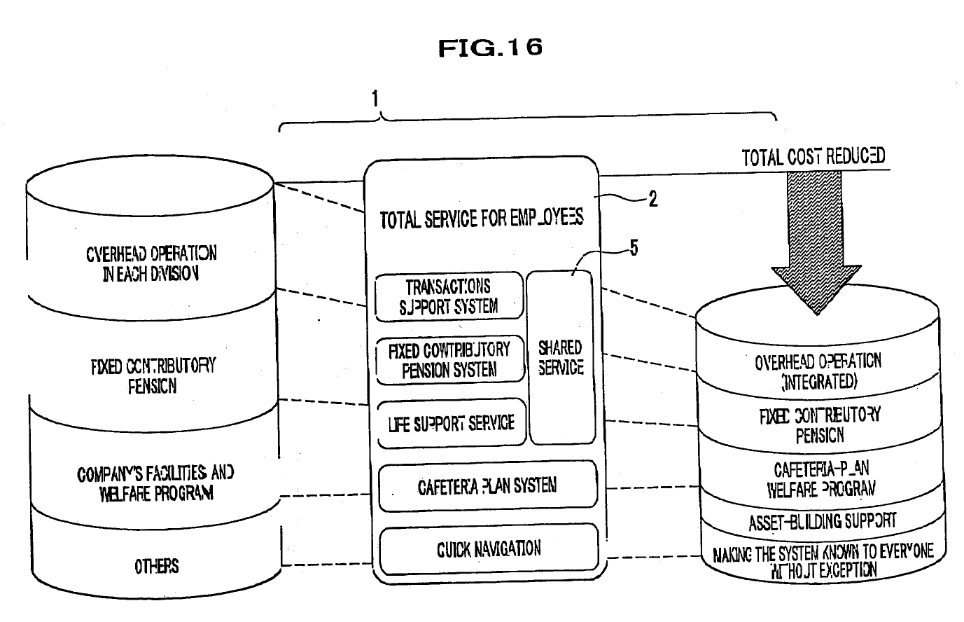

Advantageous effects of the instant embodiment will be described below with reference to FIGS. 16 through 18. As shown in FIG. 16, a company that has introduced the system as described above can reduce total costs related to the general affairs and welfare programs. To be more specific, the “one-stop” service achieved as a result of the scheme as above in which the employees 1 input necessary information by themselves, as well as a shared service 5, economizes the overhead operations. Further, linking to external resources serves to restrict the welfare expenses; for this and other reasons, the total costs resultantly can be reduced effectively without lowering the level of service.

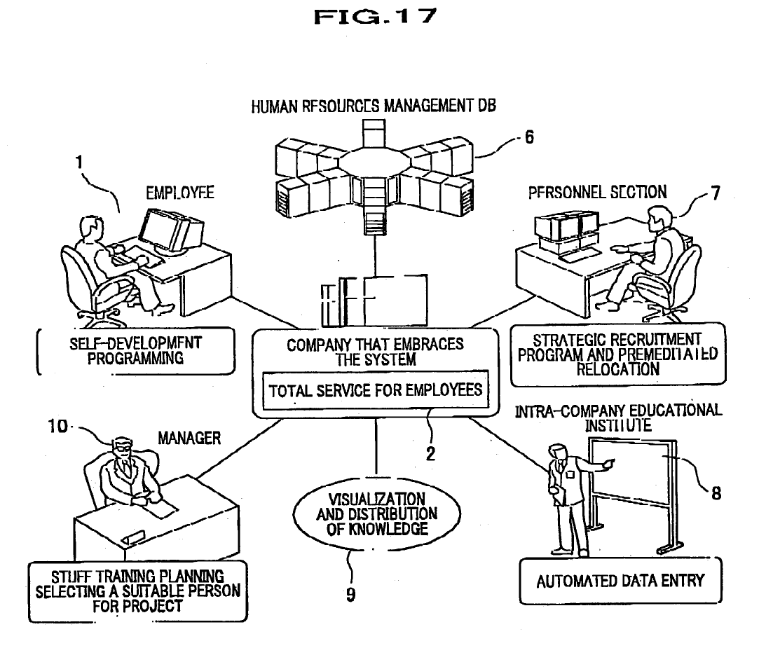

Turning to FIG. 17, it is understood that an increase in intellectual productivity can be promoted according to the instant embodiment. More specifically, the above-described embodiment of the present invention serves to realize a flexible optimum personnel reassignment by making use of human resources data bank, a strategic human resources development based upon determination of competency measured by analysis of skills and the like of employees, and utilization of visualized skills of the employees for a personnel appraisal tool. As shown in FIG. 17, the above portal site (integrated portal service) 2 is located at the center of the system, and connected via communication channels (e.g., the Internet, and intranet) with a employee 1, a human resources database 6, a personnel section 7, an intra-company educational institute 8, a visualization and distribution of knowledge 9, and a manager 10. Thus-built communications network enables profitability to be ensured through increased productivity, intelligence value to be created through shared knowledge, awareness of self-development of the employees to be raised, and personnel appraisal to be optimized by the individual database.

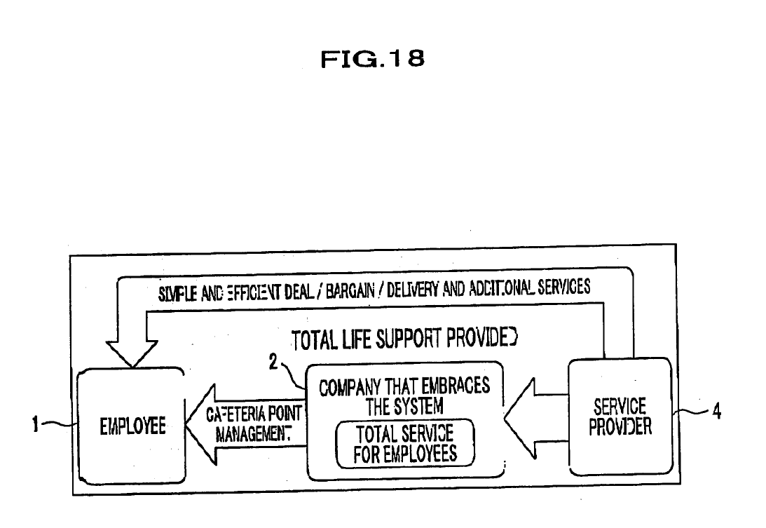

Although the advantages for a company that embraces the system has been described above with reference to FIGS. 16 and 17, the following advantageous effects for employees, which are illustrated in FIG. 18, can also be achieved with the instant embodiment. To be more specific, the above-described embodiment of the present invention provides the employees with a total life support, improved employability (e.g., a standard carrier model presented, and in-house and external training services being available) and convenience. The convenience is exemplified by additional services such as a delivery service to the office, an abundant menu of external services suitable to individual employer's needs, preferential rates, and bulk-buy discount. These advantages for the employees also serve as advantages for the company in that the company loyalties of the employees are enhanced.

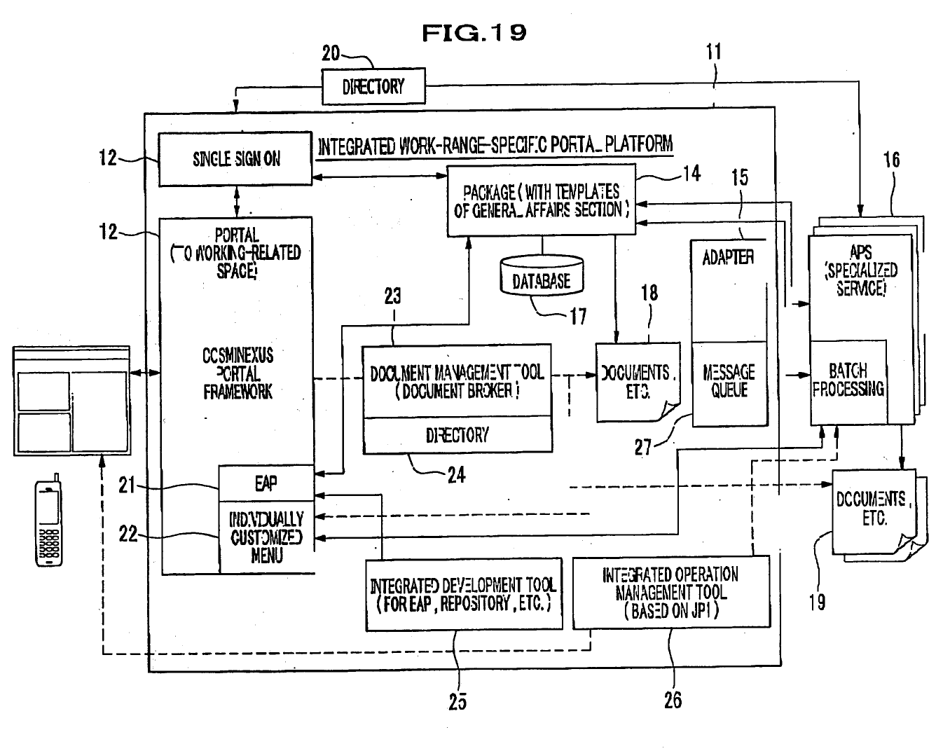

FIG. 19 shows the integrated portal architecture in the instant embodiment. Denoted by reference numeral 11 is an integrated work-range-specific portal platform as the core of the system. The platform 11 includes blocks as will be described below. A single sign on 12 is linked to a working-related space portal 13 and a general affairs section template package 14. The package 14 includes a database 17, and is linked to an ASP 16. The ASP 16 is operated by the specialized service provider 4. The ASP 16 is linked via a directory 20 to the single sign on 12. Denoted by reference numeral 15 is an adapter, which is provided with a message queue 27. The portal 13 includes an EAP (Enterprise Application Portal) 21 and an individually customized menu 22. Denoted by reference numeral 25 is an integrated development tool such as an EAP and a repository, and denoted by reference numeral 26 is an integrated operation management tool. Denoted by reference numeral 23 is a document management tool, which is provided with a directory 24 through which documents or other data 18, 19 are located. The document, etc. 18 is linked from the package 14, while the document, etc. 19 is linked from the ASP 15. The document management tool 23 is linked to the portal 13, and the tools 25 and 26 are linked to the portal 13 and the ASP 16, respectively.

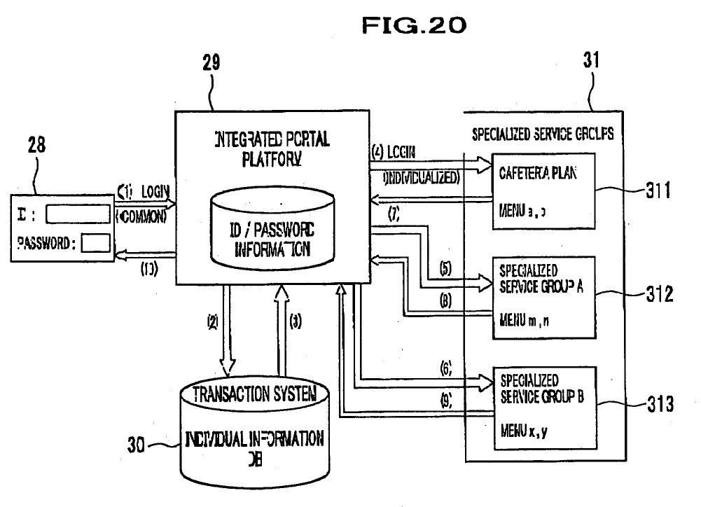

According to the present invention, when a user logs into the system in a single login operation, the user is presented with a customized menu on the screen. A description will now be given of a series of procedural steps starting with the login operation of an employee till the employee reaches services specifically arranged for the employee, with reference to FIG. 20. When an ID and password are entered on the login screen 28, an integrated portal platform 29 is responsive in step (1). The integrated portal platform 29 exercises centralized management of IDs for each of the specialized service sites available, and thereby allows the employees to sign on all the services in a single login operation. The integrated portal platform 29 consults the individual information database in the transactions system 30 using the ID and password entered by the employee who has accessed the services to verify the ID/password pair of the employee in step (2). If the ID/password pair is verified in step (3), a list of services available is customized to suit the employee using his/her individual information. To be more specific, in the front page that appears next to the login screen 28, a customized screen (“my page”) having a menu of the customized list of services is presented. Thereafter, clicking on a desired item of the menu automatically carries out an individual login operation to one of services sites corresponding thereto in specialized service groups 31 in steps (4), (5) or (6). When the employee accesses the service site 311, 312 or 313 and selects a desired item of a menu presented in the service site 311, 312 or 313, a service corresponding to the selected item of the menu is passed through the platform 29 in steps (7), (8) or (9) and then provided to the employee in step (10).

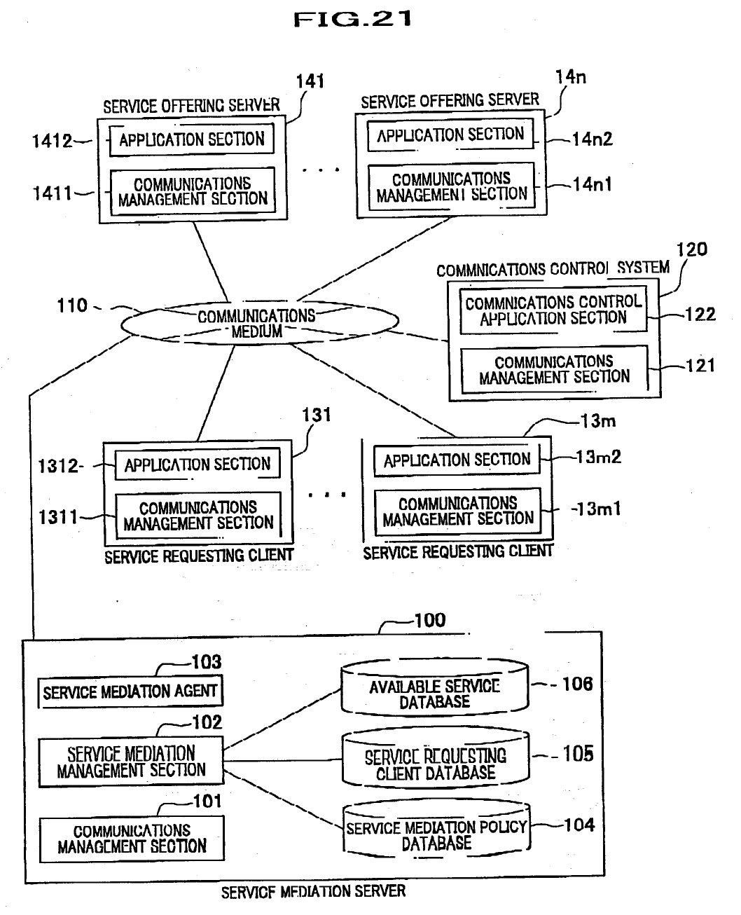

A system configuration for providing services will be described with reference to FIG. 21 et seqq.

FIG. 21 is an exemplary system configuration applicable in the present invention. To this system, four types of stations, i.e., service offering servers 141-14n, service requesting clients (employees) 131-13m, a service mediation server 100 and a communications control system 120 are connected through various kinds of communications media 110 including a wide area network or WAN. It is to be understood that each ‘section’ in the servers and clients indicates a functional part executable on the computer.

The service offering servers 141-14n are designed to furnish the system with information on available services to provide an end user (employee 1 who has accessed the system) with services directed specifically to the end user. Service providers who utilize the service offering servers 141-14n include corporate bodies such as companies, individual entrepreneurs, and the like, who hold and maintain such services. The particulars of the services to be provided in actuality include an information service such as electronic shopping malls, a request for physical distribution services such as relocation, an order for goods, a repair, arrangements for temporary workers, and the like, constituting the specialized service groups as shown in FIG. 20. Displayed on the screen is information for managing, through mediation of the service mediation server 100, persons, material goods and money that are exchanged between the service provider who uses the service offering servers 141-14n and the end user (employee) who uses the service requesting clients 131-13m.

Each of the service offering servers 141(-14n) includes a communications management section 1411(-14n1) that executes a process of communication with the communication media 110, and an application section 1412(-14u2) that executes a process of offering services to an employee as an end user through the service user through the service requesting clients 131-13m.

The service requesting clients 131 13m are terminals that each are used directly by the end user (employee) who wishes to enjoy the services as described above or that are shared by two or more of the end users. The terminals may include personal computers (PCs) that are distributed to the employees and installed in the offices, or mobile terminals that are carried on the road and used at home too by the employees; more specifically, cellular phones, personal digital assistants (or PDAs), microcellular phones (or PHSs) may serve as the terminals for use in the present invention. The terminals transmit a request via the communication media 110 to the service mediation server 100, and receives information from the service offering server 141(-14n). Exemplarily among devices usable as the service requesting clients 131-13m are dedicated terminals, PCs, workstations, multimedia kiosks, and PDAs.

Each of the service requesting clients 131(-13m) includes a communications management section 1311(-13m1) that controls a process of communication with the communication media 110, and an application section 1312(-13m2) that controls a user interface through which a user transmits a request to a service provider and receives services provided by the service provider. The service mediation server 100 executes a process of mediation for various operations between the service offering server 141(14n) and the service requesting client 131(-13m) such as control exercised over a process for finding a location and type of the services, and a process for providing information on the services. In practice, server machines usable as the service offering servers 141-14n and the service mediation server 100 include, for example, PCs, workstations, mainframe computers, and the like. The service mediation server 100 receives a request from the service requesting client 131(-13m), and determines a type of information to be provided to the service requesting client 131(-13m), based upon information on conditions of the request, individual information on the user (service requesting person) who uses the service requesting client 131(-13m) and the service provider who uses the service offering server 141( 14n), past history information thereof, and other conditions of various kinds at the time of receiving the request. Hereupon, it is understood that the individual information on the service requesting person who uses the service requesting clients 131-13m and the service providers who use the service offering servers 141-14n, and the past history information thereof have been stored in the service offering servers 141-14n.

Here, a brief description will be given of a mediation process between the service requesting client 131(-13m) and the service offering server 141(-14n). The service mediation server 100 transmits a request for information to some of the service offering servers 141-14n from which required types of information can be acquired. The service mediation server 100 then determines information to be provided to the service requesting client 131(-13m) based upon information received from the service offering servers 141-14n and information of its own, and transmits the information as thus determined to the service offering servers 141-14n.

In the above process, if a plurality of available services from two or more of the service offering servers 141-14n are transmitted to the service requesting client 131(-13m) in response to a request of the service requesting client 131(-13m), a process of synchronization of the services is carried out in the service mediation server 100, so as to provide the services from the two or more of the service offering servers 141(-14n) in a manner that meets the needs of the end user and other conditions. Hereupon, the process of synchronization includes the steps of integrating the services, presetting a time for providing the services as specified, and coordinating requests transmitted from two or more of the service requesting clients 131(-13m) to determine to provide the service only to a specific one of the service requesting clients 131(-13m).

The service mediation server 100 includes the following three sections: a communications management section 101 that executes a process of communication through connection with the communication media 110, a service mediation management section 102 that searches the service offering servers 141(-14n) meeting the conditions of a request transmitted from the service requesting client 131(-13m), and types of services requested, and manages management information databases 104, 105, 106 required for the search, and a service mediation agent 103 that controls and manages a process for providing services from the service offering server 141(-14n) located as a result of the above searching step to the service requesting client 131(-13m). The service mediation server 100 holds three types of databases which are managed by the service mediation management section 102: a service mediation policy database 104, a service requesting client database 105, and an available service database 106.

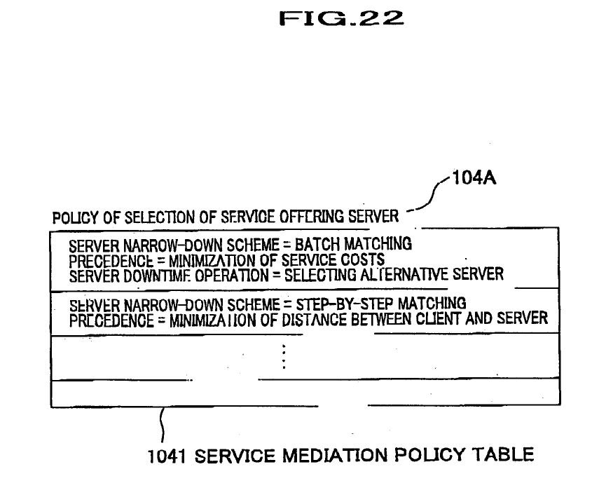

The service mediation policy database 104 holds information on conditions for searching the service offering servers 141-(14n) that best meet the conditions of a request transmitted from the service requesting client 131(-13m), and types of the services. A table for illustrating one example of the structure of the service mediation policy database is shown in FIG. 22. Information is stored for each policy of selection of service offering servers 104A. Although items of information to be stored in the table is shown in FIG. 22, a detailed description of construction will be omitted herein because there are many approaches as to how to implement the database 104. It is to be understood that items of information to be allocated for each policy of selection 104A can be dynamically changed. In other words, the service mediation policy database 104 has a flexible structure in which each field for storing the policy of selection 104A can dynamically be expanded. For example, a conceivable table structure of the service mediation policy table 1041 is: each piece of information may be arranged in one table of which a row represents policies of selection 104A of various types, and items of information clay be connected with each other in a list structure.

Some examples of data that are stored in the service mediation policy table 1041 will now be described with reference to FIG. 22. Examples of the items of information shown in FIG. 22 are “Server Narrow-Down Scheme”, “Precedence”, and “Server Downtime Operation”. Each service mediation policy table 1041 is managed in such a manner that each policy of selection 104A is uniquely identified by a policy ID. The three items of information for each policy of selection 104A as shown in the table 1041 will be described below in detail.

In one policy of selection, a batch matching is used as the “Server Narrow Down Scheme”. The batch matching is a method of retrieval in which all the specified criteria are entered for data-retrieval processing to output a list of service offering servers that match the criteria. In another policy of selection, a step-by-step matching is used as the “Server Narrow-Down Scheme” The step-by-step matching is a scheme in which the criteria are entered one by one for stepwise data-retrieval processing to output at each step a list of service offering servers and services thereof to be used to confirm that the outputted list satisfies the needs of the service requesting client.

In one policy of selection, the “Precedence” field is filled in to specify the order of selection among service offering servers in the list outputted as a result of the matching process. The order of precedence in which the servers are selected may be determined in view of minimization of service costs or minimization of distance between the service requesting client and the service offering server

In one policy of selection, the “Server Downtime Operation” field is filled in to specify whether to continue the search for servers till an alternative server is selected or to stop the search based upon the specified criteria, when the located server is found in downtime. In order to utilize the features of the service mediation policy able 1041, the data-retrieval processing commonly shared in the service mediation server 100 need be flexibly configured so that the above data-retrieval schemes and data required for the data-retrieval schemes may additionally be specified when the processing is executed. As one exemplified embodiment, a rule-based data-retrieval scheme may be adopted. The rule-based data-retrieval scheme is a technique for performing data retrieval according to conditional data, called “rule”, having a specific format.

Each policy of selection of service offering servers 104A is entered and contents thereof can be defined by an administration of the service mediation server 100 or from the service offering server 141(-14n). When a request for a service is transmitted from the service requesting client 131(-13m), a search is executed in the service mediation management section 102 using a policy of selection 104A determined by any one of the following methods. One is a method in which a service requesting client 131(-13m) specifics a policy of selection 104A. In this method, a policy of selection 104A must be indicated in “service selecting conditions” to be specified by the service requesting client 131(-13m). Another method is that one in which service selecting conditions for each service requesting client 131(-13m) are under control of the service mediation management section 102 and a policy of selection 104A to be used for each client 131(-13m) is filled in the “service selecting conditions”. In this instance, the policy of selection is treated as individual information for each client 131(-13m). The individual information for the client 131(-13m) is stored in the service requesting client database 105 in tabular form. The service requesting client database 105 is configured so flexibly that the contents of the service selecting conditions can dynamically be changed; therefore, the entries of each policy of selection recorded as part of individual information can also be changed dynamically.

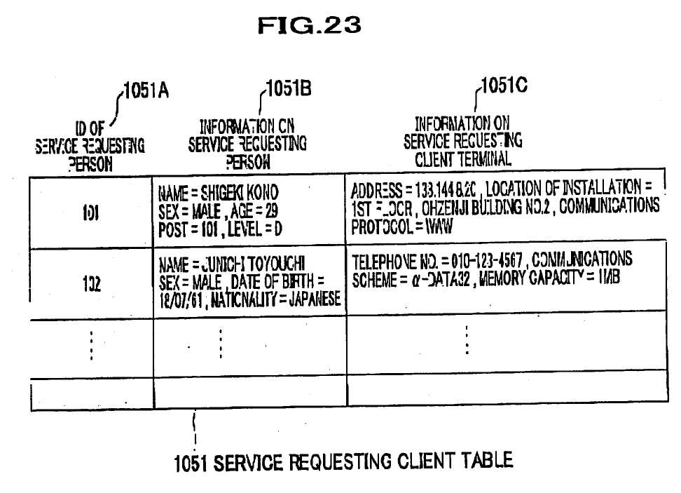

FIG. 23 shows a structure of the service requesting client database 105, as exemplified by a service requesting client table 1051. The service requesting client table 1051 is used to manage information individualized for each service requesting client 131(-13m). Specifically, the service requesting client table 1051 includes an ID of service requesting persons 1051A that is used to uniquely identify each service requesting person in the service mediation server 100 or the system, information on service requesting persons 1051B that is information individualized for each service requesting person, and information on service requesting client terminals 1051C that holds attribute information on each service requesting client terminal.

It is to be understood that structure of the table 1051 can dynamically be changed. In other words, items of information for entry in the information on service requesting persons 1051B and the information on service requesting client terminals 1051C should not have a fixed structure. Take, for example, the information on service requesting persons, the items of information may be classified into common items of information such as a name of each service requesting person, and extension items of information such as an age, a date of birth, etc. to which identified individual information having different descriptions can dynamically be entered. In particular, the extension items of information can be added by service providers who use the service offering servers or administrator of the service mediation server as search criteria for service offering server. To that end, an adoptable structure of the table may have the first column with a heading of ID of service requesting person, and subsequent columns corresponding to categorized items of information, provided as those which indicate attribute information elements of each service requesting person under each categorized item of information, with each attribute information element appended and mapped in list structure. In this instance, each service requesting client can arbitrarily select some or all of the categorized items of information, and can dynamically add the items of information to the existing items. This list structure is also applicable to management of items of information recorded in the information on service requesting client terminals 1051C such as an address and a communications type (or scheme or protocol) assigned to each client terminal.

The individual information for each service requesting person is managed using the service requesting client table 1051; thus, selecting services that can more likely satisfy the needs of an end user by grasping a preference of the end user and a history of his/her use of services can be made possible. The mediation of the service mediation server allows the end user to locate his/her own preferred services by him/herself, and makes it possible to automatically maintain/manage the history of his/her use of services in the system, thereby reducing the burdens on the end user.

Each item of the information on service requesting persons and the information on service requesting client terminals is entered by service providers who use the service offering servers or administration of the service mediation server. This is because the criteria as to what individual information is used to select services to be provided must only be determined by parties who offer the services. In addition, an entry of an item of information may be made in a variety of description formats from each service offering server 141(-14n). For example, as shown in FIG. 23, in one server, “Age” is provided as an entry of the items of information, while in another server. “Date of Birth” is provided as an entry of the items of information. To accommodate such differences in description, it is conceivable that a list for uniquely identifying each item of individual information in the service mediation server or in the system may be provided as an information item listing table. The information item listing table has common items of information defined to uniquely identify the items of information entered from each service offering server on the basis of descriptions of entries thereof. The information item listing table serves to correlate the common item of information with each item of information that is different in description but identical in meaning. For example, in a case where the information item listing table includes “Age” a common item of information, “Date of Birth” is correlated therewith as a variant of the common item of information. It is understood that the items of individual information usable in the service requesting client table selectable only among items of information recorded in the information item listing table.

The individual information to be recorded in the service requesting client table 1051 is entered each time when the service requesting client database 105 receives a request from each service requesting client. There are at least two exemplified methods for recording individual information: a first method and a second method. The first method includes selecting items of individual information to be recorded for a service requesting client 131 when the client 131 submits a request for receiving the offer of services provided through the service mediation server 100, presenting an end user having the service requesting client 131 with details of the items of information, allowing the end user a choice among the items of information, and recording the items specified by the end user in the table 1051. Which items of information are recorded in the table 1051 depends upon the user's preference. The second method is that in which the information on the service requesting person 1051B is dynamically recorded. To be more specific, the end user carries a medium, such as an IC card, in which his/her own individual information is stored, and uses the medium when requesting a preferred service, i.e., makes a request for the service with his/her individual information attached to the request. In this instance, the information on the service requesting person that has been attached to the request and transmitted to the service requesting client database is dynamically recorded in the service requesting client table, and a search for service offering servers is conducted based upon the recorded information. The second method is preferable in that it can avoid the risk of having private information of an individual released or used undesirably which risk is inherent in always holding such private information in the system.

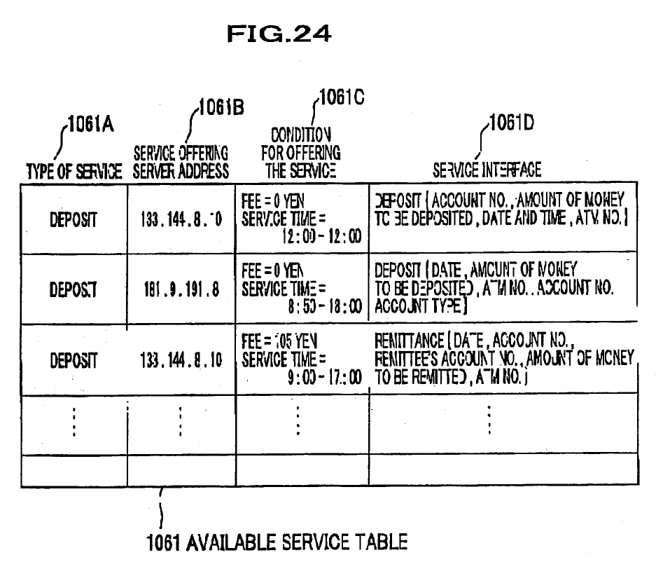

FIG. 24 shows a structure of the available service database 106, as exemplified by an available service table 1061. The available service database holds attribute information related to available services provided by service providers, such as conditions for offering the services. The available service table 1061 includes a type of each service 1061A that is used by the service offering server to identify details for each service, a service offering server address 1061B that indicates a logical location of each service offering server, a condition for offering the service 1061C that stores information on conditions for offering the service, and a service interface 1061D that has a list of interface information to be specified by the service requesting client. Among these fields of information in the table 1061, the condition for offering the serviced 1061C and the service interface 1061D should have a flexible structure that permits each item of information to be dynamically added, as described above with respect to the service requesting client table 1051. For example, the table 1061 may have a list structure for each type of services. As is the case with the information on service requesting persons, an entry of an item of information may be made in a variety of description formats from each service offering server 141(-14n). For that reason, the aforementioned information item listing table may be used to correlate the common item of information with each item of information that is described in a unique fashion.

There are at least two exemplified methods for managing the type of services 1061A: a first method and a second method. The first method is designed to define the type of services 1061 as a uniquely identifiable ID for each service offering server. In this method, allocation of the ID is left to applications in the service offering servers. In order to uniquely identify each type of services and thereby adequately manage the types of services, each type of services is paired with the service offering server address 1061B. On the other hand, the second method is designed to manage the types of services with each type of services identified uniquely in the service mediation server, and to record, in the service mediation server, information as to whether services of the type are to be offered. Thereafter, each service offering server determines what services are offered, based upon the types of services defined therein, and requests the service mediation server to record the attribute information of the available services so that the services may be searched for.

The service offering server address 1061B is a logical identifier of a server, which is independent of a physical hardware address of a communications medium. This identifier is uniquely distinguishable in the system. To uniquely identify the servers, for example, the identifiers (addresses) are adequately managed in the service mediation server in such a manner as to uniquely correspond to the servers. The identifiers are allocated each time when the service offering server applies for provision of a service thereof through the service mediation service.

The condition for offering the service 1061C is used in data-retrieval processing in the service mediation management section 102 by specifying the type of service thereof as a search criterion. The service providers who utilize the service offering servers specify, by the condition 1061C, attribute information of services which the service providers wish to offer. Those described in the attribute information, for example, as shown in FIG. 24, are the conditions of services to be offered, which include fees, service time, locations where to deposit money, a list of banks as remittees, and the like. Based upon the conditions, the optimum types of services and service offering servers are searched for in response to the request from the service requesting client.

The service interface 1061D includes parameter information the service requesting client 131 should specify when requesting a service. Information on conditions used for retrieving a type of services, and information required when offering the service after the retrieval are recorded in the service interface 1061D from the service offering server. The use of the available service table 1061 during the service retrieval processing in the service mediation management section allows the end user to make use of a service the end user truly wishes to enjoy without forcing the end user to make an effort to grasp particulars and addresses of services in a great number of service offering servers.

Since the conditions for offering the service 1061C in the available service table 1061 is structurally configured to permit dynamically adding or changing their items of information, most appropriate service can be provided according to the change in situations. To be more specific, under current circumstances where a lot of information providers have been getting into the information service business on an everyday basis and the existing services provided in the information providing computers are subject to frequent additions and changes, the end user cannot be expected to grasp all the above changes, but the dynamically changeable feature of the conditions for offering the service 1061C resultantly allows the end user to enjoy the best service at that point of time, even if only a short time has passed since a service better than any other existing services has been added.

Moreover, since the service interface 1061D in the available service table 1061 is also structurally configured to permit dynamically adding or changing their items of information, the services can easily be varied according to the system environments and the quality of information/services, so as to more satisfy the needs of the end user. Further, the service interfaces of various types of services are integrated so that the service requesting client may be notified at all times of the items of information; accordingly, the end user can select the best condition of the service at that point of time. This facilitates the comprehensive evaluation of the circumstances as described above by the end user, and allows the end user to easily select the service optimized according to the variation of the circumstances.

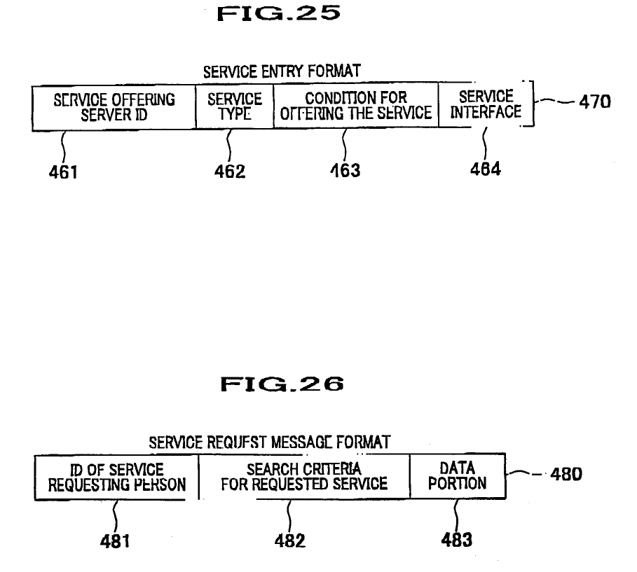

FIG. 25 shows a service entry format transmitted from the service offering server 141 to the service mediation server 100. Upon entry, the service offering server 141 must have a service offering server ID (address) obtained through any one of the above-described methods. A description that follows will be based on the promise that the service offering server 141 has already obtained its service offering server ID. The entry format includes a service offering server ID 461 of each service offering server 141(-14n), a service type ID 462 that indicates contents of services provided by the service offering server 141( 14n), a condition for offering the service 463 that indicates search criteria defined by the service offering server 141 ( 14n) for use in service-retrieval processing, a service interface 464 that indicates a type of parameter information which the service requesting client has to specify when choosing to offer the service and submits a request therefor. Each item of information constituting the service entry format has already been described above with reference to the available service table shown in FIG. 24. In this format, one or more services may be added. The format shown in FIG. 25 exemplifies a record format for one service, and multiple records in the same format may be linked with each other and transmitted together.

Shown in FIG. 26 is one example of a service request message format 480 that is used to submit a request for services from the service requesting client to the service mediation server. Although an ID of a service requesting person may be assigned using various methods as described above, it is to be understood that the following discussion is based upon the premise that the client has already obtained the ID Accordingly, the message format 480 includes the ID of the service requesting person 481 that serves to uniquely identify the service requesting client in the system, a search criteria for a requested service 482 that holds information on search criteria for use in requesting the service, and a data portion 483. It is assumed that the service request message is transmitted with the data portion containing information on a service requesting person as shown in FIG. 23. To be more specific, in cases where the information on the service requesting person is recorded in a portable media such as an IC card, the service request message is transmitted with the information on the service requesting person included in the data portion 483. In cases where the information on the service requesting person has already been stored in the service mediation server for use in data-retrieval, the data portion is not used.

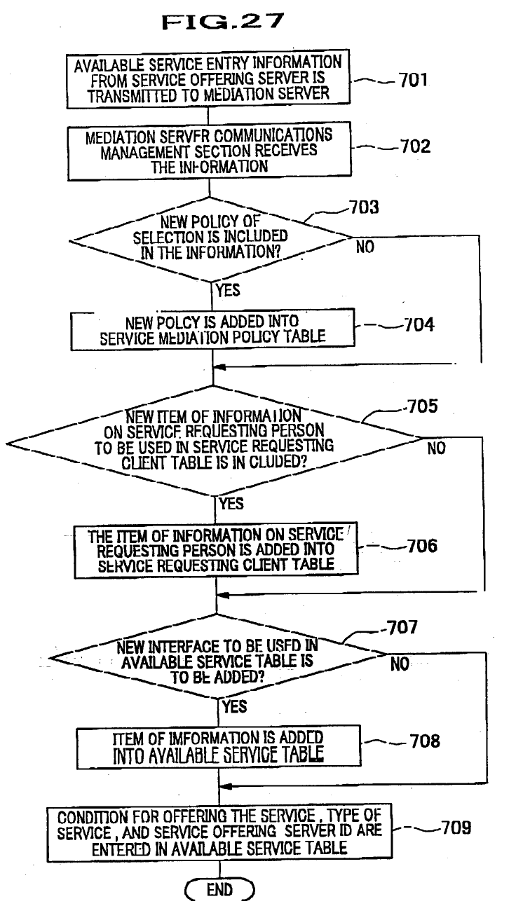

Next, a general process flow of the service mediation server 100 in the system as shown in FIG. 21 will be described below. FIG. 27 is a flowchart for a registration process of a service from a service offering server to the service mediation server 100. First, available service entry information transmitted from the service offering server is received in the communications management section 101 of the service mediation server 100 (steps 701, 702). The entry information received here in the communications management section 101 is in the service entry format 470 as shown in FIG. 25. A search for the service mediation policy database 104 is conducted to determine whether a new policy that is not recorded in the service mediation policy database 104 in the service mediation server 100 is included in the entry information (step 703). If it is determined that a new policy is included in the entry information, then information on the new policy is added into the service mediation policy table 1041 (step 704). Such a process of adding a new policy is optional, and thus if no new policy is found in the entry information, the above process of adding a new policy is not necessary. Next, a search for the service requesting client database 105 is conducted to determine whether a new item of information on the service requesting person to be used in the service requesting client table 1051 is included in the entry information (step 705). If it is determined that a new item of information is included in the entry information, then the new item of information is added into the information item listing table related to the service requesting client table 1051, and also into the field 1051B of the information on service requesting persons of the service requesting client table 1051 (step 706). If no new item of information to be added in the information on the service requesting person is included in the entry information, the step 706 should be bypassed.

Next, a search for the available service database 106 is conducted to determine whether a new service interface is to be added from the entry information (step 707). If a new item of information to be specified upon request for a new service is required for the purpose of offering the new service, then the new item of information is added into the information item listing table related to items of information for the service interface 1061D of the available service table 1061 (step 708). If no new item of information to be added is included in the entry information, the step 708 is not executed. When the step of adding the new item of information is completed, the condition for offering the service, the type of service and the service offering server address (ID) for the service as submitted in the entry information are added into the items of the available service table 1061 (step 709). Now, the registration process of one service is complete.

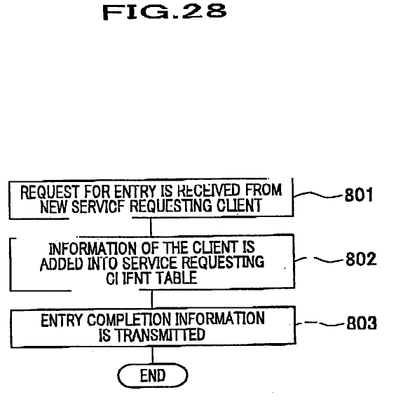

Referring to FIG. 28, a description will be given of a process flow of adding information on a service requesting client into the service mediation server. First, a request for entry transmitted from a new service requesting client is received in the communications management section 101 of the service mediation server 100 (step 801). Next, based upon information in the request for entry, an ID is assigned to the service requesting client, and information on the client is entered into the service requesting client table 1051 (step 802). In this step, in cases where the information on the client is recorded in the service mediation server, the information on the service requesting person is also recorded in the service requesting client table 1051. On the contrary, in cases where the service requesting person carries his/her information in a portable medium, the information on the service requesting person is not recorded in the service requesting client table 1051. A notification of entry completion is then transmitted to the client (step 803), and the process is concluded.

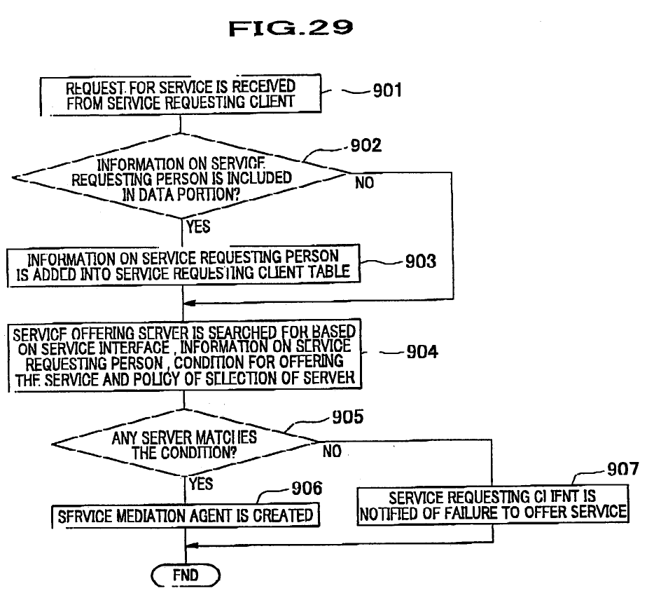

Referring to FIG. 29, a description will be given of a process performed when a request for a service is received from a service requesting client. First, a service request message is received in the communications management section 101 (step 901). The format of the service request message received herein is as shown in FIG. 26. Referring to the message format, the service request message is scanned over to determine whether the data portion thereof contains information on the service requesting person (step 902). In this step, if it is determined that the information on the service requesting person is found, the information on the service requesting person recorded in the data portion of the service request message format is stored in the equivalent field of the service requesting client table 1051 (step 903).

Next, based upon the information on service requesting persons and information on service requesting client terminal recorded in the service requesting client table 1051, conditions for requesting and offering each service specified in the service interface 1061D of the available service table 1061, and policies of selection of service offering servers 104A recorded in the service mediation policy table 1041, a search for the requested service is executed in the service mediation management section 102 (step 904). After the search is completed, if at least one of the servers is found to be relevant, a service mediation agent for managing a process of offering a service that corresponds to the requested service is created (step 906). If no server is found to be relevant, a notification of failure in offering the requested server is transmitted to the service requesting client (step 907). At this stage, the process in the service mediation management section 102 is complete, and the communications management section 101 waits for the next request for services.

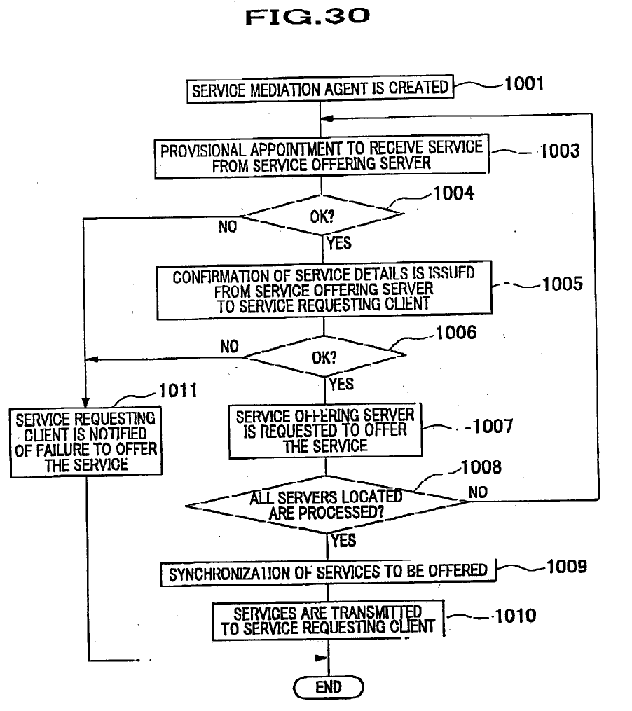

FIG. 30 shows a general flow of the service mediation agent in the service mediation server 100. Once a service to be offered and a service offering server are located in the service mediation management section 102, a service mediation agent is created (step 1001). Then, a provisional appointment to receive service from the service offering server is made (step 1003). If it is determined in step 1004 that the service offering server is ready, a confirmation of service details provided from the service offering server is issued to the service requesting client (step 1005). If the client confirms that the service provided from the service offering server is what the client wishes to enjoy (step 1006), the client requests the service offering server to offer the service (step 1007). If the provisional appointment could not be made or if the client refused to receive the service due to the details thereof informed by the service offering server, then a notification of failure in offering the requested service is transmitted to the service requesting client (step 1011). If it is determined in step 1008 that a request for services to the service offering servers are transmitted to all the servers that have been located in the previous search, synchronization of services to be offered from the servers is carried out (step 1009). The synchronization includes processes of integrating information from more than one service offering server, making an appointment with a server to offer the service on a specified point of time, temporarily storing details of services of the service offering server, supporting correlated services between the servers, and others. When the synchronization of the services is complete, the services to be offered are transmitted to the service requesting client (step 1010), and the process of the service mediation agent is concluded.

The service mediation agent may be created and terminated for each request for services, and may be created and terminated for each service requesting client. In the latter instance, when the above process has been completed, the service mediation agent waits for another request for services from the same service requesting client.

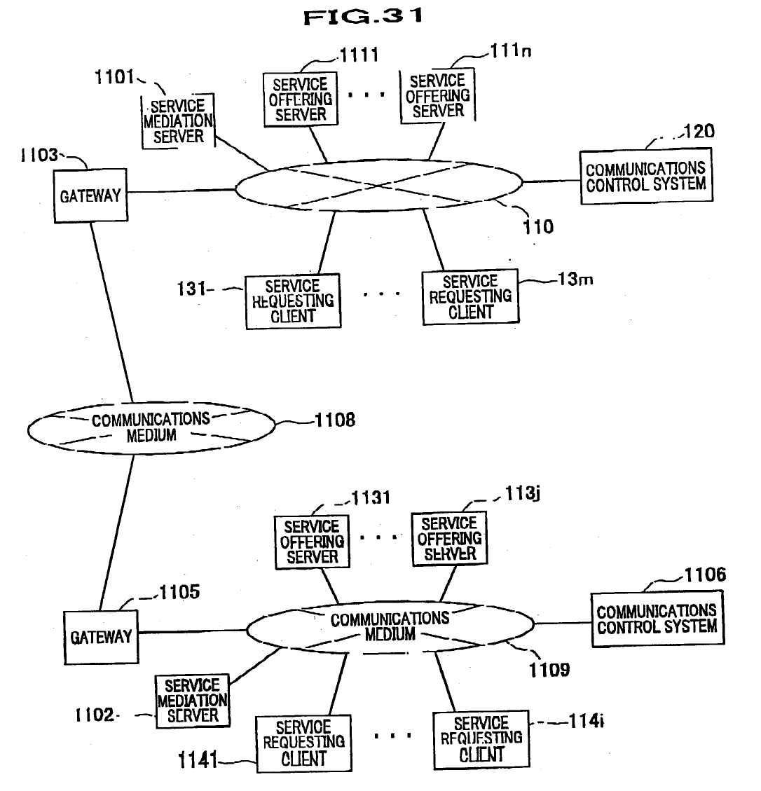

Next, a description will be given of another exemplified embodiment of the system configuration, different from that which was described above with reference to FIG. 21. FIG. 31 illustrates this second system configuration. In addition to the elements shown in FIG. 21, the second system configuration further includes multiple interconnected communications media that constitute a network, on which service requesting clients, service offering servers, service mediation servers, communications control system, and gateways. It is assumed that the communications medium 110 and the communications medium 1109 can communicate with each other via the communications medium 1108 which is connected to both networks via the gateway 1103 and the gateway 1105. With consideration given to uncertainty in communication performance of each communications medium, leaving all the traffics of information on requests and offers of services to communication across the different media could possibly raise a problem; therefore, the service mediation servers 1101, 1102 are installed in each communications medium. Moreover, more than one service mediation server may be connected with one communication medium so that the service mediation servers may operate in harmony with each other.

In the present embodiment, a method for implementing a process of selecting optimum services among services provided from service offering servers of which operations are adequately managed respectively by service mediation servers that operate in harmony with each other, in response to a request from each service requesting client which request is adequately managed respectively by the service mediation servers.

The internal structures of each service mediation server, service requesting client, service offering server are identical with those shown in FIG. 21, but are different in that each database in the service mediation servers are shared among multiple service mediation servers. Such a database sharing feature is one newly added to the present embodiment. Each of the information stored in the service mediation policy database 104, the service requesting client database 105 and the available service database 106 is transferred to other specific service mediation servers. The other servers are regarded as specific by the following three methods: a first method, a second method and a third method. In the first method, the service entry information is transferred to all the service mediation servers present in the system. According to this method, all the service mediation servers in the system share the information on services of all the service offering servers in the system. In the second method, all the service mediation servers are divided into predetermined groups, and the service mediation server transfers the service entry information to all other service mediation servers within the group to which the service mediation server belongs. According to this method, the information on services is shared within the group of the service mediation servers. In the third method, the service mediation servers are correlated to other predetermined service mediation servers that should operate in harmony therewith, and the service entry information is shared among the correlated servers.

In the present embodiment as shown in FIG. 31, one service mediation server is located for each communications medium, and each service mediation server 1102, 1101 manages service requesting clients 1141-1141, 131-13m, and service offering servers 1131-113j, 1111 111n. An described above, information on the service mediation server 1102 is shared in advance with the other service mediation server 1101. In this embodiment, upon receipt of a request for services from the service requesting client 1141, the service mediation server 1102 conducts a search for services in the service mediation management section 102 of its own, and forwards conditions of the request to the service mediation management section of the service mediation server 1102 in which another search for the services is conducted. If the service mediation server 1101 finds an optimum service as a result of the search, the service mediation server 1101 notifies the service mediation management section of the other server 1102 of the result. The service mediation management section also starts a service mediation agent to exercise control over an offer of the services not only when locating the optimum service in its own communications medium 1109, but also when locating the same in the service offering server 1111 managed by the service mediation server 1101 in the other communication medium 110.

In the present embodiment, the service requesting clients that manage themselves and the service mediation servers that have service offering servers share information with each other, when each service mediation server conduct a search for services and provide the optimum services in response to a request from the client. Consequently, the present embodiment makes it possible to provide a system configuration and feature that can more flexibly and easily add, retrieve and offer services even under conditions where the number of clients and servers has increased more and the system has expanded its network area wide.

Structures of each table stored in the service mediation management section are substantially the same as shown in FIGS. 22 through 24, and thus can flexibly respond to a dynamic change in attribute.

Next, a description will be focused on which steps in FIGS. 27-30 are those in which communication between the service mediation servers is performed. The service mediation server notifies service mediation management sections of the other service mediation servers of information on update in the following steps in FIG. 27: step 704 in which a new policy is added into the service mediation policy table; step 706 in which the item of information on a service requesting person is added into the service requesting client table; step 708 in which the item of information on a service interface is added into the available service table; and step 709 in which the condition for offering the service and other attribute information are entered in the available service table.

Similarly, referring to FIG. 28, the service mediation management sections of the other service mediation servers are notified of entry information in step 802 in which the information on the service requesting person is added into the service requesting client table. Turning to FIG. 29, in steps 902 and 903 in which a request for services is received to obtain search criteria from the service request format, and the information on the service requesting person is added into the service requesting client table, the service mediation management sections of the other service mediation servers are notified of the information on the request and the service requesting person. Further, in step 905, the service mediation server waits for completion of determination as to whether any service offering server and services thereof under control of the other service mediation servers match the conditions, and in step 906, a service mediation agent for managing a process of offering the service, if any, that best matches the request among services including those managed by the other service mediation servers is created. In FIG. 30, the provisional appointment in step 1003 and the request for offering the service in step 1007 are transmitted via the gateways across the different communications media.

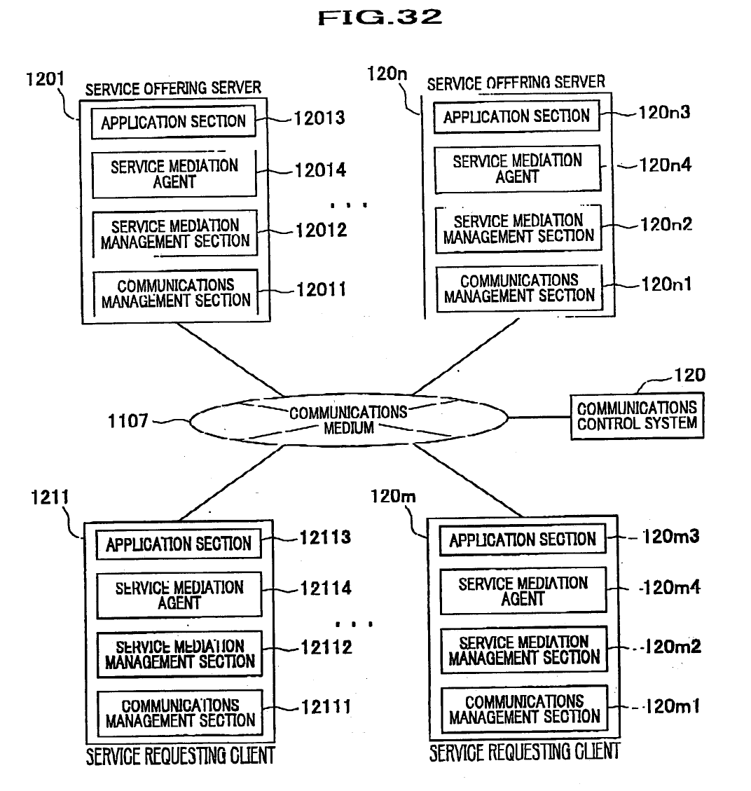

Next, a description will be given of a third exemplified embodiment of the system configuration with reference to FIG. 32. In this embodiment, the functions of the service mediation servers are implemented in the service offering servers 1201-120n and the service requesting clients 1211-121n. Utilizing the same methods as illustrated above for the second embodiment, information to be managed is shared among service mediation management sections 12012-120n2 and 12112-121m2, and the optimum services are searched for and provided across the network via the communications media. In this embodiment, the service mediation servers as separate computer units are omitted, and the mediation functions and the service mediation agent functions implemented in the service mediation management sections are distributed among the servers and clients, so that even if any of the mediation functions is disabled, the service-retrieval/provision processes can advantageously be carried out without suspension by making use of the other of the mediation functions. Although all the servers and clients have such mediation functions in FIG. 32, it is understood that not every server and client should necessarily be provided the mediation functions but such a system configuration that some specific servers and clients determined on a certain criterion may be provided with the mediation functions may serve to achieve the above described advantages.

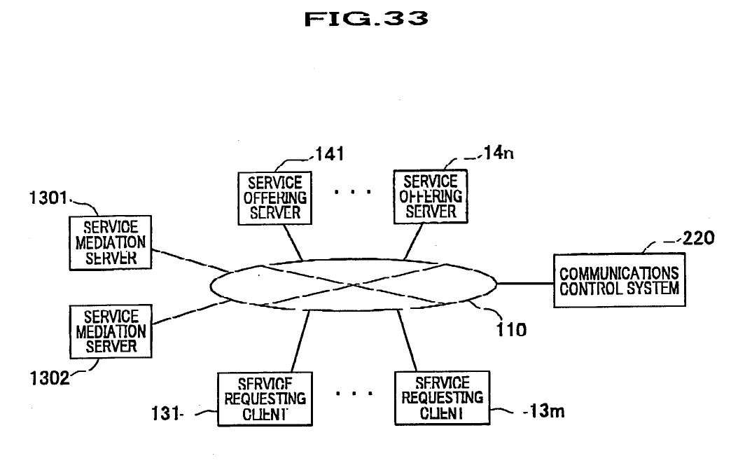

Next, a brief description will be given of a fourth exemplified embodiment of the system configuration with reference to FIG. 33. There exist a plurality of service requesting clients 131-13m and a plurality of service offering servers 141-14n each connected with one communication medium. Also provided in the same network are a plurality of the service mediation servers 1301, 1302. Communication on the network through the communications medium is under control of the communications control system 220. The both service mediation servers 1301 and 1302, and other if any, manage the same clients and servers, so that the clients and servers are managed redundantly. This configuration advantageously enables distribution of loads in mediation process in which the mediation serer 1302 if assigned an excessive load may request the mediation servers 1301 and/or others to perform the mediation process as delegate. Moreover, if any of the mediation servers gets into trouble, this configuration enables other mediation server(s) to take over the mediation process of the mediation server in trouble so as to process requests for services received after the trouble. These consecutive operations as above can be achieved on the premise that attribute information of the service requesting clients and the service offering servers as described in conjunction with the second embodiment is shared among the service mediation servers 1301, 1302 (and others, if any). Although two of the service mediation servers 1301 and 1302 are illustrated in FIG. 33, it is to be understood that the number of the service mediation servers is exemplary only, and that three or more of the service mediation servers may expect cooperation of each other in performing the process of mediation between the clients and the servers.

Although the preferred embodiments of the present invention have been described above, various modifications and changes may be made in the present invention without departing from the spirit and scope thereof.

According to the present invention, as described above, useful and inventive systems and methods can be provided in which employees can sign in a customized menu of services in a single login operation and can save themselves performing login operations each time to enter each of the services.

What is claimed is:

1. A total service support system for employees of an organization including a divisional organization and a corporate body, comprising:
an individual information database in which individual information on each employee is stored;
an information database in which information of the organization available to the employees is stored; and
a server that provides links to external service sites provided in affiliation to the organization,
wherein each of the databases is connected with the server and a plurality of terminals available to the employees through means of communication;
wherein each of the terminals includes a visual display unit, on a screen of which appears a login prompt to be responded to by one of the employees who accesses the system using the terminal, and the server obtains individual information of the employee by searching the individual information database based upon an ID and password inputted by the employee, to display a navigation screen designed specifically for the employee; and
wherein the navigation screen has a menu of items related to the information database and those related to the external service sites, arranged in a manner customized to suit the employee.

2. A total service support system for employees according to claim 1, wherein the individual information includes information selected from the group consisting of date of birth, family makeup, residence data, commute data, marital status, and membership, in addition to essential information of sex, age, date of entry into the organization, section and post.

3. A total service support system for employees according to claim 1, wherein the server exercises centralized management of IDs accessible to each of the external service sites, utilizing information obtained from the individual information database, so that the employee signs on internal services as well as external services provided in the external service sites in a single login operation.

4. A total service support system for employees according to claim 1, further comprising an additional individual information database in which individual information on voluntary registrants is stored, which registrants include family members of the employees and/or retired persons who have been registered therein and allowed to access the system at their own wishes,
wherein the server is connected with the additional individual information database through means of communication, and obtains individual information of one of the voluntary registrants who has accessed the system by searching the additional individual information database based upon an ID and password inputted by the voluntary registrant, to display a navigation screen designed specifically for the voluntary registrant; and
wherein the navigation screen has a menu of items related to the information database and those related to the external service sites, arranged in a manner customized to suit the voluntary registrant.

5. A total service support method for employees comprising the steps of:
allowing the employees to log in to a system in response to a login prompt displayed on a screen of a computer terminal of each employee;
allowing a server to obtain by means of login information inputted by the employee individual information of the employee who has accessed the system, so that the employee signs on some of affiliated service sites preassigned to the employee at the same time; and
displaying a listing of the service sites on the screen, wherein selection and arrangement of the service sites to be displayed in the listing is customized in accordance with the individual information.

6. A total service support method for employees according to claim 5, wherein in addition to the listing of the service sites, specific items of notification information selected according to who and when the employee has accessed the system are displayed.

7. A total service support method for employees according to claim 5, wherein the individual information includes information selected from the group consisting of date of birth, family makeup, residence data, commute data, marital status, and membership, in addition to essential information of sex, age, date of entry into the organization, section and post.

8. A total service support method for employees according to claim 5, wherein the server exercises centralized management of IDS accessible to each of the service sites, utilizing the individual information obtained by means of the login information, so that the employee signs on internal services as well as external services provided in the affiliated service sites in a single login operation.

9. A total service support method for employees according to claim 5, wherein the server obtains individual information of a voluntary registrant who accessed the system among those including family members of the employees and/or retired persons who have been registered in an individual information database of the system and allowed to access the system at their own wishes, by searching the individual information database based upon an ID and password inputted by the voluntary registrant, to display a navigation screen designed specifically for the voluntary registrant; and
wherein the navigation screen has a menu of items related to internal services and those related to external services provided in the affiliated service sites, arranged in a manner customized to suit the voluntary registrant.
